(19) United States
(12) Patent Application Publication
(10) Pub. No.: US 2015/0095166 A1
(43) Pub. Date: Apr. 2, 2015

(54) SYSTEM, METHOD AND COMPUTER PROGRAM FOR PROVIDING QUALITATIVE AD BIDDING

(71) Applicant: ORIOLE MEDIA CORPORATION dbc Juice Mobile, TORONTO (CA)

(72) Inventor: NEIL TERRANCE SWEENEY, TORONTO (CA)

(21) Appl. No.: 14/528,731

(22) Filed: Oct. 30, 2014

Related U.S. Application Data
(63) Continuation of application No. PCT/CA2014/000123, filed on Feb. 19, 2014.
(60) Provisional application No. 61/766,393, filed on Feb. 19, 2013.

(51) Int. Cl. G06Q 30/02

(52) U.S. Cl. CPC G06Q 30/0275
USPC 705/14.71

(57) ABSTRACT

A computer network implemented method and a computer system is provided that improves the effectiveness of buying and selling of online or mobile advertising units. A planning utility is provided for improving the effectiveness of buys of online or mobile media properties, the planning utility including a media buying dashboard. An analyzer is provided, which is part of or linked to the planning utility, which when executed analyzes a series of attributes for each media property, including the one or more qualitative attributes, and receives information regarding the marketing objectives of a buyer, and generates advertising buying recommendations or suggestions, and present these buying recommendations or suggestions to the buyer. The method and system can use static or dynamic information for rating different publishers and their media properties to improve advertising unit buying/selling.

### CROSS REFERENCE TO RELATED APPLICATION(S)

This application claims all benefit, including priority, of PCT Application Serial No. PCT/CA2014/000123 filed on Feb. 19, 2014 and U.S. Provisional Patent Application Ser. No. 61/766,393, filed Feb. 19, 2013, entitled SYSTEM, METHOD AND COMPUTER PROGRAM FOR PROVIDING QUALITATIVE AD BIDDING, the entire contents of which is incorporated herein by this reference.

### FIELD OF THE INVENTION

This invention relates generally to media buying and ad networks. This invention relates more specifically to ad exchanges, supply side platforms (SSP's), demand side platforms (DSP's) and real time buying engines (RTB's), for buying and selling electronic advertising.

### BACKGROUND

Various Internet based platforms are known for designing, implementing and executing marketing campaigns. For example, various technology platforms exist that facilitate buying and selling of online and/or mobile advertising inventories through ad networks. Ad exchanges permit this across multiple ad networks. “Demand-side-platforms” or “DSPs” allow advertisers to manage multiple ad exchange and data exchange accounts to optimize ad placements. Many of these platforms include real-time bidding functionality or “RTB” which allows advertisers to programmatically bid on ad impressions that meet specific criteria in real-time (usually demographic criteria of a user who has requested a page from a site that is connected to an Exchange). These platforms allow optimization based generally on price alone, for example, cost per thousand, costs-per-click and cost-per-acquisition, but generally treat media content as a commodity and do not reflect that some ad inventory qualifies as “premium” ad inventory due for example to the affiliated publishing brand (for example: BBC is viewed as premium media property).

Additionally, prior art platforms, such as SSP's, DSP's and RTB's, generally help manage electronic advertising purchases using audience segmentation tools. These tools generally rely on demographic data that may be generated in part by presumptions made based on consumer browsing history. For example, the outcome of an ad placement may be to buy an ad impression presented to a twenty-five year old mother of two. One issue is that prior art platforms do not differentiate in regards to the content or media in which the ad is placed. For example, one destination for the same consumer (who meets the same demographic criteria) may be viewed as being more valuable than another destination. The differences in how different media is viewed by consumers affect the impact that an ad has on a consumer. This in turn affects the performance of an ad campaign depending on the “environment” in which the consumer meeting demographic criteria is targeted, as determined by qualitative aspects of the content where the ad is placed.

There is a need for a platform that addresses these important environmental aspects of digital advertising campaigns.

Digital media has resulted in a significant increase in available content and, as a result, an important increase in available inventory to advertisers. The proliferation of content incorporating ad units (such as display advertising) has resulted in a digital advertising market where currently inventory exceeds supply, the end result generally being commoditization of rates that publishers can charge for placement of ads in their ad inventory. Commoditization is particularly prevalent in online advertising due to the fact that ad supply inventory is greater than demand and advertisers are competing for ad inventory purely on price.

Online advertising permits the use of audience segmentation tools to target specific consumers using for example demographic criteria. In mobile advertising on the other hand, these tools are less developed and therefore harder to distinguish one piece of inventory from another and as a result, media buyers default to price.

For new entrants to publishing, the ability to monetize content has never been easier with the proliferation of advertising networks that connect advertisers with the ever increasing list of digital publishers. For these new entrants, $1 in advertising when juxtaposed against a business model with little overhead and recurring costs, is sufficient to make a business. Unfortunately the same cannot be said for traditional media companies that view themselves as “premium” publishers. For these publishers, who may operate for example an Internet site associated with a major newspaper, and who incur significant expenses (for example in paying journalists to create content), the commoditization of advertising rates has posed serious business challenges. And yet the content created by premium publishers matters to many consumers.

In addition, in digital media there has been a disintermediation of the publisher and the content. A great deal of the content that is consumed is from individual creators and aggregators, rather than from traditional publishers that were generally considered to be an authoritative voice. Search, FACEBOOK™ and TWITTER™ are the most obvious examples of mechanisms used by individual creators to distribute their content. The growing consumption of content from individual creators, consumed through these widely adopted platforms, places further financial pressure on publishers, and especially premium publishers who generally have higher content creation costs.

More consumers are adopting smart phones and use these to consume content. As a result, online advertising has been migrating to mobile, and this poses further challenges to advertisers, brands, publishers and consumers. For example, there is significant opportunity cost associated with gaining traction in emerging media such as mobile, which is often at the expense of core business. Also, mobile advertising is subject to rapid innovation, requiring participants with little expertise to adapt to the fast pace of change in this domain. As a result, for mobile advertising, many stakeholders have defaulted to traditional online media buying and planning methodologies as well as traditional online technology and platforms that are not designed for mobile advertising. Therefore prior art solutions for managing online advertising purchases, including because of the factors explained above, often results in fixation on price and generally limits opportunities to design campaigns in a targeted manner due to the lack of understanding of mobile, and also a lack of tools that permit advertisers and publishers to make better add buying/selling related decisions. Brands, and the agencies that represent them, face numerous challenges in the mobile space. Brands who are buying audience views to sell their product or promote their brand, using prior art solutions (such as prior art ad networks or ad exchanges), have limited visibility into the quality of the product they are purchasing, and generally do not have the tools or knowledge to judge the efficacy of the campaigns that are purchased on their behalf.

The agencies that represent these brands operate under a business model that is increasingly characterized by low margins. This is one reason why the agencies tend to use programmatic ad buying solutions that may include features that streamline the buying process in order to improve margin and reduce overhead.

The comprehension by agencies of mobile advertising and how it differs from the more familiar online space may be limited, and even given a better understanding of the space, they may not have the bandwidth to devote to optimizing mobile buys. Further, there is resistance to learn about mobile advertising because mobile generally represents a small portion of an agency's business. These factors result in a somewhat simplistic approach to mobile advertising buys, where these are mainly made based on cost and based on decisions that are simple to make. For example many buyers make buying decisions for mobile that are aligned with decisions that were made for buying ad impressions for online media. The differences in the possible impact that can be achieved with one mobile piece of inventory versus another are often not understood or addressed using prior art solutions.

The same is true as stated earlier for display advertising given that context relevant to targeting consumers outside of demographic criteria is generally not addressed by prior art solutions. Existing approaches generally do not provide to brands and agencies sufficient visibility into the relative value of ad inventories, based on for example targeting objectives. More specifically, prior art solutions do not permit advertisers to differentiate between one ad impression and another ad impression.

Significant commoditization pressures exist in connection with mobile inventory, as explained above. For clarity, in relation to online advertising techniques such as the use of cookies and caching provide support for targeting of audience segments, however, there are limitations on the effectiveness of these audience targeting techniques and therefore price becomes an important factor.

This is even more pronounced in mobile advertising where there are currently less, and virtually no, opportunities for targeting audience segments, and therefore buyers need to focus on price.

A skilled reader will understand that use of contextual data for example for targeting consumers is based on inferences regarding for example consumer interest. This approach is commonly used, but often this is the case not because it provides strong campaign performance but rather because there is no viable alternative.

Also, publishers often view their own product as being worth far more than it really is on the open market. Additionally, their ability to prove to agencies and brands that their inventory has a premium value is increasingly difficult due to the limited tools available to agencies or publishers that measure qualitative differences between publications for example. The fixation on price compensates for low margins on the agency side but punishes publishers with valuable content that may also be expensive to produce.

Publishers generally do not have a clear understanding of mobile advertising, and this puts severe limits on their ability to communicate those qualities that differentiate their product beyond price. Their ability to devote resources to understanding and exploiting the mobile space is also limited, since at present, their mobile inventory represents an insignificant portion of their revenue stream.

Even those publishers that understand these factors are generally ill-equipped to find solutions for them, since they are typically large entities that are slow to react, and the mobile advertising space is changing quickly. Also, many publishers lack scale in their publications that allows them to address the affecting development of mobile advertising related strategies. Even larger organizations generally lack the internal resources to innovate with new technologies. This results in a heavy reliance on third party vendors to service their interests in the mobile space, and a complete lack of institutional knowledge on how the mobile space works.

Consumers generally don't enjoy ads. They are interested however in receiving a lower volume of high quality targeted ads and most certainly not interested in being inundated with poorly targeted ads.

There is a need for a new technology and approach to digital advertising that enables premium publishers to command better prices, in a way that meets the interests of brands and agencies. There is also need for such a technology and platform that can address the nuances of mobile advertising.

### SUMMARY

In one aspect, a computer network implemented system is provided for improving the effectiveness of buying and selling digital advertising for mobile comprising: (A) a registration component for registering a plurality of publishers to a computer network implemented platform (“platform”), each publisher being associated with one or more digital media properties, and further for registering one or more attributes associated with the digital media properties (“content attributes”), these attributes including one or more content quality attributes; (B) an advertising campaign component that permits an advertiser, a brand, or their representative (“buyer”), to log to the platform one or more advertising campaigns, along with one or more target attributes of the ad impressions sought by the buyer (“ad impression attributes”); and (C) a reverse auction component that permits one or more publishers, or their representatives (“publishers”), to plan a bid on, and optionally bid for, the ad impressions; wherein the reverse auction component automatically allocates the ad impressions across the digital media properties of the bidding publishers based on a mapping of the content attributes to the ad impression attributes and the qualitative content attributes.

In another system aspect, the mapping promotes allocation of the ad impressions across the digital media properties of the bidding publishers based on a fit between the ad impression attributes and the content quality attributes.

In another aspect, the system comprises an advertising campaign planning component that assists buyers in designing the target ad impression attributes.

In a still other aspect, the system comprises a bid planning component that permits the publishers to design and specify their bids on ad impressions through the reverse auction component.

In another aspect, a computer network implemented method for improving the effectiveness of buying and selling of online or mobile advertising units is provided comprising: (A) registering a plurality of publishers to a computer network implemented platform (“platform”), each publisher being associated with one or more digital media properties; (B) receiving, or generating, one or more qualitative attributes associated with the digital media properties; (C) an advertiser, brand, or their representative (“buyer”) logging to the platform one or more advertising campaigns, along with one or more attributes of the ad impressions sought by the buyer; (D) one or more publishers, or their representatives (“publishers”), planning a bid, and optionally bidding on, the ad impressions based on one or more bidding strategies that are based on the ad impressions; and (E) if publishers bid on the ad impressions (“bidding publishers”), automatically allocating the ad impressions across the digital media properties of the bidding publishers based on a mapping of the content qualitative attributes to the ad impression attributes.

In another aspect, the system includes a rating system that enables the rating of digital media properties based on the qualitative attributes, and this rating is used automatically by the reverse auction component to allocate ad impressions amongst two or more publishers based in part on the qualitative attributes in addition to other relevant attributes such as demographic criteria.

In accordance with an aspect of the present invention, there is provided a computer network implemented system comprising: at least one computer processor and at least one non-transitory computer readable medium storing computer processing instructions; a registration component; an advertising campaign component; and a reverse auction component; wherein, upon execution of the computer processing instructions by the at least one computer processor: the registration component associates at least one publisher with at least one digital media property, and associates at least one attribute with the at least one digital media property, the at least one attribute including at least one content quality attribute; the advertising campaign component associates at least one advertising campaign with at least one advertising impression attribute, the at least one advertising campaign comprising a plurality of advertising impressions to be allocated; the reverse auction component provides for the processing of at least one bid by the at least one publisher to allocate at least a portion of the plurality of advertising impressions of a respective one of the at least one advertising campaign to the at least one digital media property associated with the at least one publisher; and the reverse auction component allocates the at least a portion of the plurality of advertising impressions to the respective at least one digital media property that is a subject of the at least one bid based at least partly on a determined correspondence between the at least one attribute associated with the respective at least one digital media property and the respective at least one advertising impression attribute.

In accordance with an aspect of the present invention, there is provided a computer network implemented method performed by at least one computing, the method comprising: associating at least one publisher with at least one digital media property, and associating at least one attribute with the at least one digital media property, the at least one attribute including at least one content quality attribute; associating at least one advertising campaign with at least one advertising impression attribute, the at least one advertising campaign comprising a plurality of advertising impressions to be allocated; providing for the processing of at least one bid by the at least one publisher to allocate at least a portion of the plurality of advertising impressions of a respective one of the at least one advertising campaign to the at least one digital media property associated with the at least one publisher; and allocating the at least a portion of the plurality of advertising impressions to the respective at least one digital media property that is a subject of the at least one bid based at least partly on a determined correspondence between the at least one attribute associated with the respective at least one digital media property and the respective at least one advertising impression attribute.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

The invention will be better understood and objects of the invention will become apparent when consideration is given to the following detailed description thereof. Such description makes reference to the annexed drawings wherein:

FIG. 1 is a system diagram illustrating the components of the present invention, in one representative implementation thereof;

FIG. 2 is a further system diagram illustrating the possible computed implemented workflows in accordance with the present invention;

FIG. 3 is a further workflow diagram illustrating the multi-phase reverse auction method of the present invention;

FIG. 4 is a diagram providing a generic computer hardware and software implementation of certain aspects of the invention, as detailed in the description;

FIG. 5 is an exemplary table listing information used in an example bid allocation described herein;

FIG. 6 if an exemplary table listing information used in an example bid allocation described herein;

FIG. 7 is a system diagram illustrating component of the present invention, in one representative implementation thereof; and

FIGS. 8A-8C illustrate workflow diagrams showing processes of an implementation of the reverse auction component of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

### Definitions

It is useful to explain the scope of the invention by defining one or more terms used in this disclosure.

The ratio of the number of selections (e.g., click-throughs) of an ad to the number of impressions of the ad (i.e., the number of times an ad is rendered) is defined as the “click-through rate” (CTR) of an ad.

A “conversion” is said to occur when a user consummates a transaction related to a previously served ad. What constitutes a conversion may vary from case to case and can be determined in a variety of ways. For example, a conversion may occur when a user clicks on an ad and is referred to an advertiser's Internet page, or makes a purchase before leaving an Internet page. In some cases a “conversion” may require that such a transaction occur within a predetermined time such as X number of days.

The ratio of the number of conversions to the number of impressions of the ad (i.e., the number of times an ad is rendered) and the ratio of the number of conversions to the number of selections (or the number of some other earlier event) are both referred to as the “conversion rate.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” can be content in any medium on which ads can be presented. A property may include online content (e.g., a website, an online game, a social networking site), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties”. Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

An entity controlling a property may be referred to as a “publisher” in this disclosure. A publisher may be a media company for example. The publisher may also be any other content owner such as an author of the content, or entity that has the rights to reproduce the content, or the right to prepare derivative works of the content, rights to display or perform the content publicly, and/or other prescribed rights in the content.

A “buyer” is typically an agency or a brand, or person or entity hired by an agency or brand. The buyer plans media buys, and then executes them by purchasing inventory.

“CPM” refers “cost per one thousand impression”.

“CPA” refers to “cost per acquisition”, which is the same as “CPC” or “cost per click” or “cost per conversion”. CPA and CPC both refer to the cost of acquiring a customer.

It is noted that the examples set out in this disclosure discuss principally CPM, however, a skilled reader will understand that the present invention may be used to improve buys/sells of advertising regardless of the advertising media asset used (such as video or display advertising); and further that the present invention may be used in relation to different cost models and biddable units e.g. for CPM as well as for CPA and CPC.

### Platform

In one aspect, a computer network implemented platform is provided that acts as a trusted intermediary between advertisers and publishers (the “platform”). Prior art solutions for addressing aspects of the marketplace for placement of ads in content generally address the needs of either an advertiser or a publisher, but not both. The inventors have realized that solutions based on a business model that favours the advertiser or the publisher are not sustainable and a more sustainable model is one where both parties benefit from the outcome.

One of the insights of the inventors is that there is a need and opportunity to create a computer platform that acts as an intermediary between, and that automatically, in an intelligent manner, balances the interests of advertisers and publishers, based on relevant parameters that may vary from ad placement to ad placement. The platform disclosed herein accomplishes this as part of an efficient and scalable system. The platform as described incorporates solutions to numerous design and technical challenges.

The operation of the platform may be based on the operator of the platform creating partnerships with both publishers and buyers. The platform may include innovative tools that allow publishers to manage their ad inventory and intelligently plan bids on available inventory offers, and advertisers to design and implement campaigns, each thereby providing information that is logged, processed and analyzed by the platform and used to adjust the price associated with ad inventory depending on its relative value, as further explained below. Furthermore, the platform is designed to accomplish this result in an efficient and scalable way that supports the real time or near real time operations involved in bidding for ad impressions through ad networks. Specifically, the system of the present invention may provide for a publisher to expose, in real-time, available inventory to advertisers and brands for direct or guaranteed delivery buys in bulk. This is in contrast to existing systems (SSPs) that expose unsold inventory to exchanges for real-time impression level purchase (neither in bulk or guaranteed).

The present invention may be implemented as a plug-in or extension to a publisher's ad server for managing inventory by (1) Exposing available or unsold inventory to advertisers; and (2) allowing the publisher to dynamically bid based on the level of available inventory by percentage of inventory and type of inventory segment (e.g. tablet, geo, app/site section). The present system may act as a yield management tool directly integrated into the publisher's ad server.

Additionally, the platform, as explained below, incorporates numerous innovative features and services that are based on mobile advertising expertise, thus permitting advertisers and publishers to participate in this growing, and constantly evolving, mobile ad marketplace in an efficient manner.

More particularly, the platform is designed and implemented to provide a unique and innovative advertising marketplace that is used by (a) publishers to promote ad inventory and make more intelligent decisions about how they would like to sell their inventory and the types of campaigns that they would like to participate in; by (b) advertisers to place ads in digital media (web and mobile); and by (c) consumers to access ads that are relevant to them. The platform may also include a series of tools that enable (a) publishers to develop strategies for promoting their ad inventory effectively, and (b) buyers to develop strategies that meet their business objectives such as reaching groups of consumers that meet particular demographic criteria.

In one aspect, the present invention provides an intelligent consumer targeting tool that provides better targeting of consumers by optionally using demographic targeting and also, for the first time, using environmental targeting based on qualitative attributes of publisher content.

The platform provides a mechanism for advertisers to place ads (or buyers to do so on behalf of advertisers), and allocate advertising budgets, based on qualitative parameters, and not solely quantitative matters, or pricing that does not reflect qualitative parameters. Qualitative parameters may be based on the advertisers' understanding of the quality of the publisher. Brands will typically purchase ad inventory at a higher price given that the publisher property matches the quality of the advertisers brand that they're happy to be associated with. The platform unlocks the premium value of particular ad inventory, when used by particular consumers to access particular ads; and reduces the commoditization of digital ads that results from use of prior art platforms and ad networks.

In accordance with an aspect of the present invention, there is provided a computer network implemented system. The system includes a registration component, an advertising campaign component, and a reverse auction component. The registration component associates at least one publisher with at least one digital media property, and associates at least one attribute with the at least one digital media property, the at least one attribute including at least one content quality attribute. The advertising campaign component associates at least one advertising campaign with at least one advertising impression attribute, the at least one advertising campaign comprising a plurality of advertising impressions to be allocated. The reverse auction component provides for the processing of at least one bid by the at least one publisher to allocate at least a portion of the plurality of advertising impressions of a respective one of the at least one advertising campaign to the at least one digital media property associated with the at least one publisher. The reverse auction component also allocates the at least a portion of the plurality of advertising impressions to the respective at least one digital media property that is a subject of the at least one bid based at least partly on a determined correspondence between the at least one attribute associated with the respective at least one digital media property and the respective at least one advertising impression attribute. Each component may be implemented in hardware or software, by one or more logical or physical devices or services.

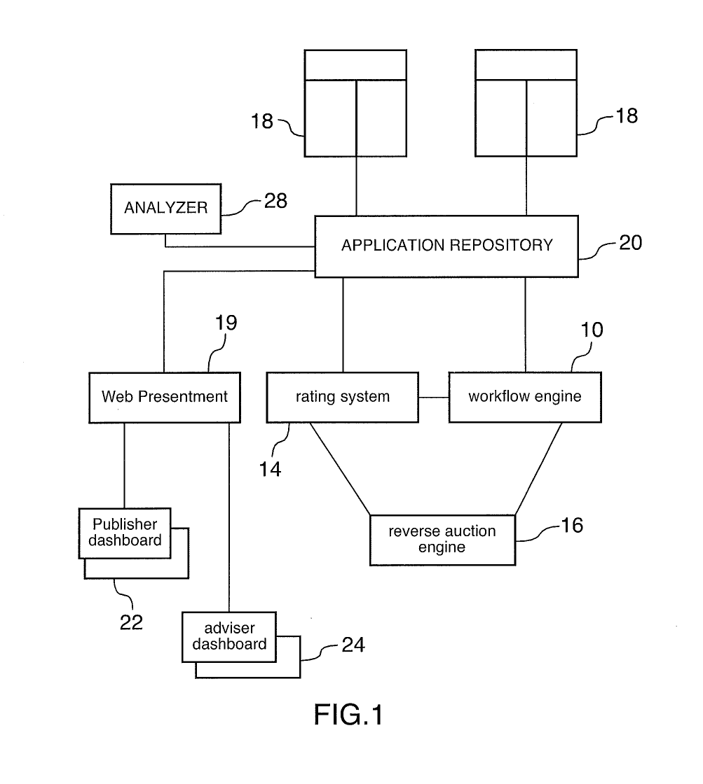

Components of the system/platform, in one implementation, as shown in FIG. 1, may include: (a) a workflow engine (10); (b) one or more ad servers (12); (c) a rating system (14); and (d) a reverse auction engine or system (16) (the “RA”).

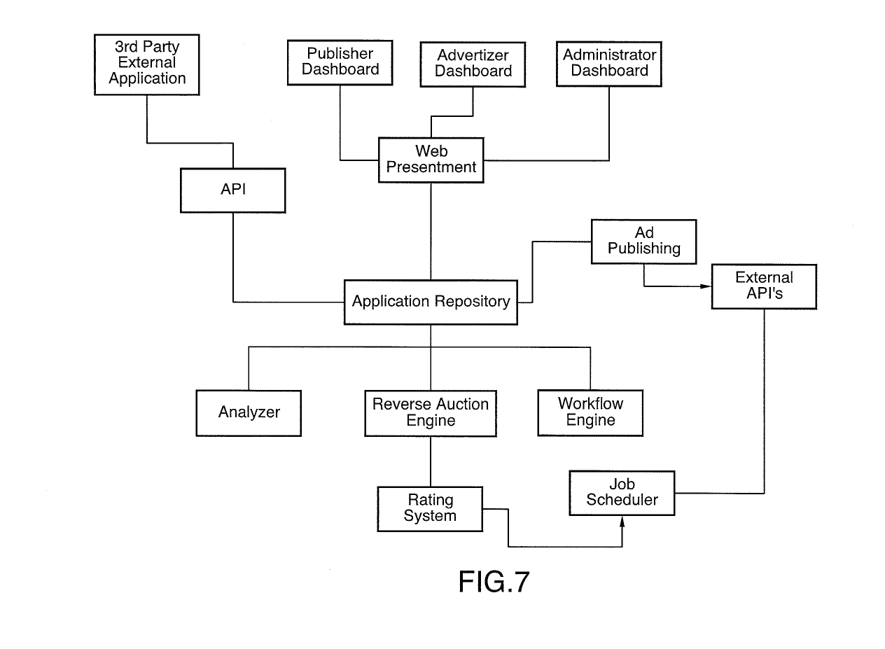

Also, as shown in FIG. 1, the system/platform may include: a Portal/Dashboard for advertisers to submit campaigns; a Portal/Dashboard for Publishers to view offers and bid for campaign dollars; a rating system, for rating publishers used in the automated reverse auction engine to determine ad allocations (wins); and a reporting and analytics engine for displaying the results of the Campaigns and how they're doing. For example, the workflow engine 10, together with the buyer/advertiser dashboard 24 may implement the advertising campaign component. Similarly, for example, the workflow engine 10, together with the publisher dashboard 22 may implement the registration component. Another exemplary implementation of the system of the present invention is shown in FIG. 7.

The platform as a whole is designed to accommodate both users who are involved in the demand side of buying/selling of ads, and also users who are involved in the supply side of buying/selling ads. Also, the platform provides tools (such as planning tools) that enable buyers to design a digital ad buying strategy, and also publishers to design a digital ad selling strategy. Exposing unsold inventory and dynamically pricing the secondary sales channel may be a selling strategy which may be provided for by the system of the present invention.

As explained herein, the platform may also include functionality for processing transactions in connection with buying/selling digital ads. The platform may include for example an ad exchange for this purpose that may be integrated with the other features of the present invention. For example, the planning tools may be used to develop a buy or sell strategy, and then the ad exchange may be used to execute on the buy or sell strategy in relation to a particular campaign or set of ad inventory. The system of the present invention could be used to manage some or all of a publisher's available inventory. This may be accomplished by the system (1) exposing the inventory to advertisers for direct guaranteed buys through the aforementioned reverse auction mechanism, or (2) exposing the remainder to lower revenue, non-guaranteed RTB exchanges. The system may provide for the ability to switch between both of these modes, which may provide for improved margins or campaign effectiveness.

The platform may include one or more servers (18) or a server farm. A server application or application repository (20) may implement the features of the workflow engine (10), rating system (14), and the reverse auction engine (16), in one possible implementation.

In another aspect, the server application (20) may implement a publisher dashboard (22) and also an advertiser dashboard or buyer dashboard (24) that allows publishers and advertisers to access their respective planning/strategy development tools provided by the platform to design campaigns in an intelligent manner; monitor and test the effectiveness of campaigns to generate performance metrics; and improve future campaigns based on the performance metrics. In one implementation, the server application (20) includes a web presentment utility (19) that presents the content of the publisher dashboard (22) and the buyer dashboard (24). The use of the performance metrics may result for example in advertiser A placing ads B in a way that is weighted toward select ad inventory C, which was never possible before.

The computer system described herein, including through the publisher dashboard (22) and the buyer dashboard (24), provides a series of planning tools that enables publishers to plan their sells of electronic ad inventory in a more intelligent and effective way, and buyers to plan their buys digital ad inventory in a more effective manner because associated buys perform better because environmental factors are addressed. These planning tools embody a series of intelligent operations that are described below.

The rating system (14) of the present system is a per se novel and innovative system component that uses cumulative data based on a number of factors including unique view (“UVs”), third party data, quality of applications, as well as historical performance of campaigns using ad impressions with defined criteria so as to calculate the “media value” of ad impressions. The cumulative data used may include a number of unique viewers, click-through rate (“CTR”), demographics, app store ratings, and bid rate. These ratings support predictive fulfillment which is not possible using conventional DSP's that treat every ad impression buy as “new”. The operation of the rating system (14) is explained in greater detail in the “Example in Operation” section.

The publisher dashboard 22 may present a series of user interface screens to a publisher user. One interface screen of the publisher dashboard 22 may provide for the creation of an auction bid. Properties (or categories) of the bid that may be defined may include: rich media (yes/no); video (yes/no); advertisement resolution size (e.g. mobile: 320×50); geographic targeting (e.g. Ontario); number of (flight) impressions; publisher channels (e.g. Automotive, News, Sports); demographic age range (e.g. 18-34); and demographic gender (e.g. adult male and adult female). The bid interface screen may provide for the publisher user to manage bids for each digital media property associated with the publisher by the registration component. This screen, or another screen, may present to the publisher user the maximum number of impressions available of the digital media property for bidding, and an estimated number of impressions. The publisher user may also select a bid rate. The publisher dashboard 22 may then calculate an estimated revenue for the bid information. The publisher may place the bid or not.

Another screen of the publisher dashboard 22 may include various drop-down menus or other user interface selection tools for selecting any of the bid properties listed above.

The publisher dashboard 22 may provide a screen that allows the publisher to input details of each respective digital media property by platform type. For example, a digital media property may appear on a variety of mobile platforms, such as iOS, Android, BlackBerry, and Windows. The publisher dashboard 22 may provide for the publisher user to input details for the digital media property for each of these, and other, platforms. The details may include: number of monthly impressions; number of unique views; click through rate; and number of ads per page. These details may be provided for the digital media property overall or broken down for particular subsets of the digital media property, optionally including: front page; news section; and sports section. Another screen of the publisher dashboard 22 may provide for the entry of geographic locations, such as by: city, province/state, country, or any other indication of geographic region.

### Ad Server

The platform may include its own ad network or ad exchange, or may provide an ad serving solution that links to one or more third party ad networks (such as for example DoubleClick™ from GOOGLE or Mocean from Mojiva™, or ad platforms that address mobile advertising such as DoubleClick for Mobile™ (“DFM), M'Ocean™ or Amobee™). In relation to existing third party ad networks, the present system may be integrated with existing resources so as to permit better decision-making, both in terms of pricing of inventory by publishers, and ad impression buys by brands or the ad agencies that represent them.

A skilled reader will understand that if a third party ad server is used, it is important that it be possible to build robust solutions that incorporate the features described herein.

In one possible implementation, the server application (20) connects to an API (26) that may be configured to interface with one or more ad servers (12) associated with an ad server in order to interoperate with an ad network associated with the ad server so as to provide the solutions described in this disclosure. A skilled reader will understand that various implementations are possible.

### Workflow Engine

The platform may include a workflow engine (10), which may be implemented as one or more applications, or one or more modules of the server application (20). The workflow engine (10) may be configured so that when it is executed, one or more workflows are provided that enable the interactions between the different types of users of the platform as described herein, and in particular buying and selling of online and/or mobile advertising inventories through ad networks in accordance with the novel and innovative approach described herein.

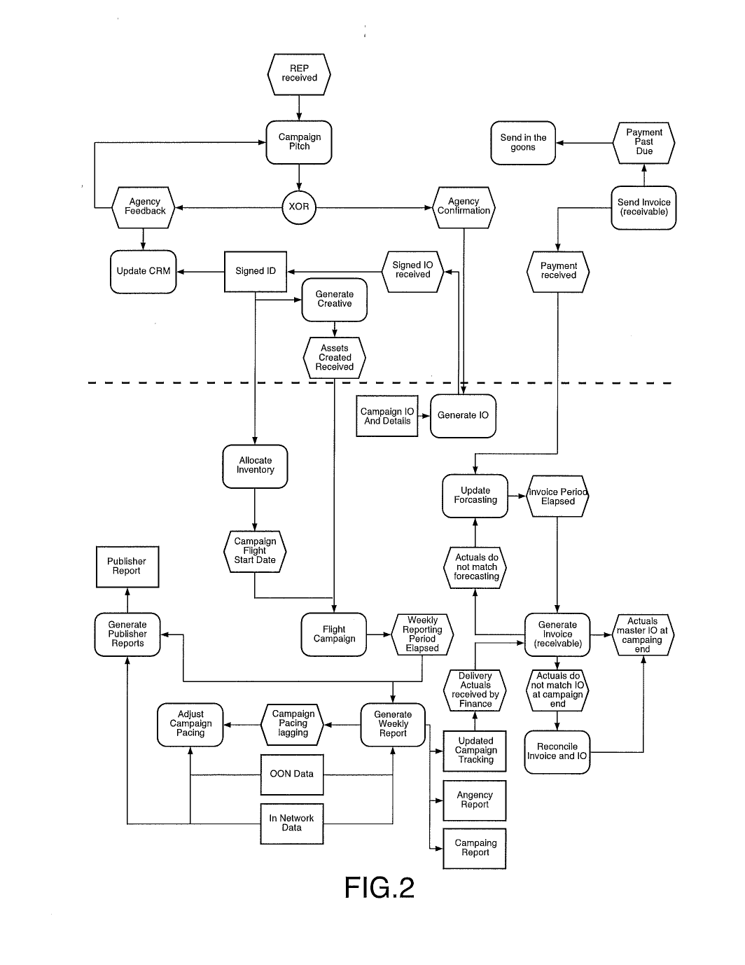

In another aspect, the present invention may include an end-to-end workflow that enables publishers in a self-directed way to provide information concerning their publishing assets, that is then used by the rating system (14) to reflect qualitative parameters particular to an ad impression or group of ad impressions, as further explained below. The system of the present invention may also be configured to pull some or all of a publisher's information concerning publishing assets directly from the publisher's systems or servers. The various steps including as described in the examples below, and as illustrated in FIG. 2, may be implemented using the workflow engine (10).

FIG. 2 illustrates a plurality of possible workflows that constitute particular aspects of the computer implemented method of the present invention.

In accordance with one implementation:

A sales team associated with the operator of the platform receives an RFP for a mobile advertising campaign. Individuals on the sales team craft a proposal and pitch to the submitting agency or advertiser. There can be additional dialogue between sales and the agency to modify the proposal. If the proposal is accepted, the sales team drafts an insertion order (“IO”) that captures the details of the campaign (dates, ad units, creative, targeting, etc.) which is sent to the agency for signature and approval. The approved IO is then sent to both the operations team and the finance team of the company that operates the platform as described herein.

The operations team usually invites publishers to bid for the impressions and based on the qualitative attributes of the publisher and bid price, allocations are determined automatically by the reverse auction and rating components. Operations may allocate impressions to publishers that have agreements with the operator of the platform. Generally speaking, invites are made based on the type of campaign and the type of publisher. This includes the intended audience, the type of targeting (if any) required which may require fulfilment by a particular ad server (as not all ad servers support all types of targeting—for example some ad servers support latitude/longitude targeting and others do not). Additionally, the operations team may make these allocations while keeping track of the margin on the buy. Once the allocations are made, the operations team may change the allocation based on the margins they're trying to protect, and the system of the present invention may switch to real-time bidding to increase margins. In other words, the operations teams generally ensures that the difference in cost between the publishers being used in the campaign (a cost generally borne by the operator of the platform) and the price at which the campaign is sold (which is paid to the operator of the platform usually by the advertiser or sometimes by a brand) maintains a sufficient margin.

At this point in the workflow, the finance team may use the IO to forecast revenue and to prepare tentative invoices (both payable and receivable). These tentative invoices will be reconciled against the actual costs after the campaign has started.

After the campaign start date has been reached and the campaign is live, the operations team continually monitors the fulfillment of that campaign, for example using one or more tools provided by the platform. This involves monitoring the number of ads delivered by each publisher and determining whether the pacing is such that the overall order will be fulfilled. Publishers that are pacing behind may be removed from the buy and the relevant impressions reallocated to other publishers, as the number one priority for the operations teams is generally to ensure that the full number of ad units bought by the advertiser are actually served. If pacing has been satisfied, the operations team's next priority is to ensure that the campaign performance (usually measured in terms of click-through rate) meets a certain threshold. If not, the operations team may again reallocate to other publishers to satisfy this criteria (while still maintaining pacing). If this objective is also being met, the operations team can also consider the margin, and possibly reallocate amongst publishers to increase the margin (while still satisfying the previous two criteria).

For campaigns that span multiple months, invoices to both publishers and advertisers can be prepared at month end. This may involve querying an ad server of the platform for the number of ads served on behalf of a plurality of publishers associated with the platform, as well as requesting those numbers from our out-of-network partners. Invoicing also occurs at the end of the campaign.

The workflow engine (10) may be implemented as an application on a cloud based computing platform. The workflow engine (10) may also be implemented as a standalone solution incorporating a managed database.

### Reverse Auction Utility

In one aspect, the reverse auction utility (16) (also referred to as a reverse auction component or RA system) is configured to aggregate publisher inventory and buys of buyers into a single, powerful marketplace, as explained below. The RA system (16) may take bids from publishers for individual campaigns, and automatically allocates ad inventory through a novel and innovative mechanism that dynamically adjusts those bids based on a predetermined characterization of the quality of the bidder's inventory, as well as the amount of campaign inventory that has already been assigned to the bidder.

The RA system (16) of the present invention may be based on an approach that is the opposite of how prior art ad networks generally operate. Contrary to prior art solutions, it is publishers who bid on allocation of impressions from ad campaigns, instead of the standard way of buyers bidding on ad impressions from publishers. An implication of the reverse auction method and system disclosed herein is that the arbitrage element that tends to accentuate commoditization of ad inventory is removed, as explained above.

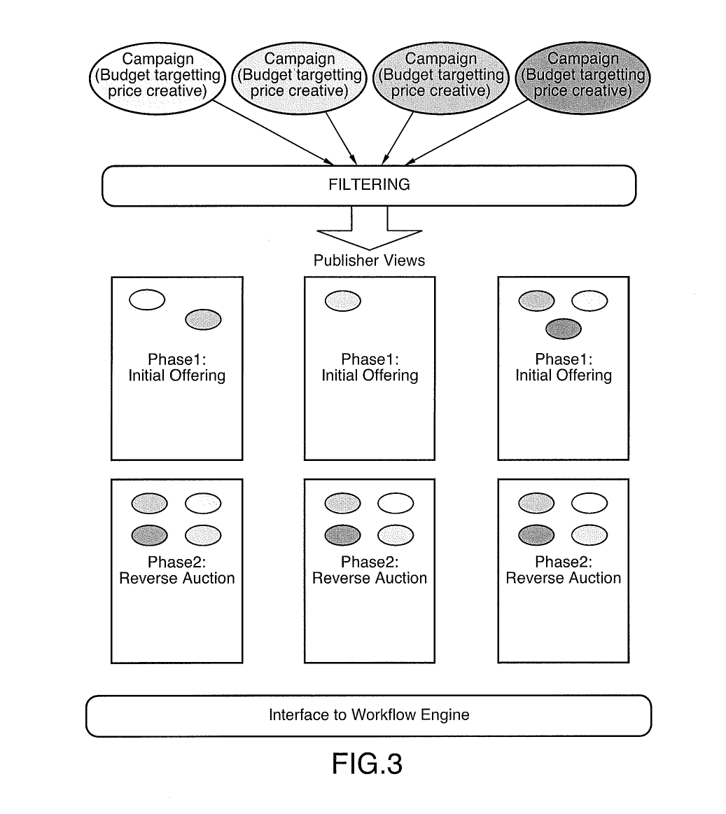

The RA system (14) may implement novel and innovative multi-phase reverse auction method as depicted in FIG. 3. As previously stated, campaigns may be entered via insertion order into the workflow engine (10) and be propagated through to the RA system (16). Campaigns entered into the RA system (16) may include the following parameters: (i) budget, (ii) targeting parameters, (iii) channel classification, and (iv) creative content.

In one aspect of the present invention, operation of the RA system (16) uses information regarding publishers and their content that enables the qualitative differentiation of content in the platform. This information may be expressed using the rating system (14) described in greater detail below.

In one aspect, this information may be obtained, or may be obtained initially by acquiring this information and loading the information to the platform. For example, the RA system (16) may be provided so that publishers can log in and provide this information using an optional self-serve on-boarding process. In one implementation, participation of publishers in the platform may require that they log in and provide certain information that is relevant to the operations of the rating system (14).

For example, publishers may be required to provide information for example regarding their reach, install base of an application, audience demographics, channel, quality of ad spaces, content structure (such as a publication having a “BUSINESS” and “SPORTS” section) and associated parameters, and contracted price. By giving publishers control over these variables, publishers will have visibility into the RA process and how it is affected by the qualitative characteristics of their publications. This will give publishers perspective on how their publications compare to those of other publishers participating in the RA process, and offer a long term incentive to improve the quality of their offerings in order to remain competitive in the RA market. In one aspect, this information (e.g. reach, install base, content structure etc.), can be acquired directly from the Publisher's ad server through a direct integration.

One particular aspect of the invention is that the platform is designed to provide qualitative information to publishers, and its impact on performance of the allocations of campaigns that the publisher would receive. The system of the present invention may provide this information through various tools that are provided by the platform. In one aspect, this educates publishers and may lead to more intelligent pricing of inventory by publishers. For example, the platform helps publishers develop a more realistic view of the value of their inventory. This may improve price to advertisers and allow publishers to clear inventory but at a better price than what their inventory may command using prior art approaches.

In one aspect, the platform helps resolve a digital buying flaw that exists in the digital media realm, as this is addressed by prior art solutions. Namely, consumers generally recognize that some brands are worth more than others yet this is not is not typically reflected in digital media buying. This is because prior art solutions such as ad exchanges and real time bidding systems are based on algorithms that are biased toward price and default to arbitrage. This promotes commoditization of digital media ads.

In contrast, the platform is designed to recognize environmental differences that affect the real value of digital media and that are not addressed adequately in context based targeting solutions that are largely based on only demographics.

A skilled reader will understand that many brands and publishers understand these flaws in available solutions (such as ad exchanges) and currently address these using largely by decision-making by analysts and use of manual processes. This adds overhead and may not provide optimal performance. The present invention in contrast resolves this digital media buying flaw in a way that does not add overhead and that provides improvement in results for both publishers and buyers.

Significantly, one of the consequences of the design and operation of the platform is that improvements are provided without the need for investment in analysis capabilities. The system may reward higher quality apps with more impressions therefore the agency does not need to invest in analysis capabilities.

In one aspect, an on-boarding process is provided that captures information in the platform that is used to quantitatively and qualitatively characterize each publisher's ad inventory. This characterization may include both technological information (for example in the case of a mobile application type of application, ad serving SDK implemented, type of ads supported), as well as demographic and audience information (such as gender or age splits of audience), may include qualitative information (such as app store ratings, as described in more detail below) and may allow for the initial discovery of a publication when an ad buy is being allocated both in Phase 1 and Phase 2 (as described herein). A skilled reader will understand that it is desirable that the answers provided as part of on-boarding are comprehensive, especially because this information—and the characterization of the ad inventory based on this will have a significant impact on the matching of campaigns to publishers during Phase 1, as well as determining the outcome of the reverse auction in Phase 2.

Because a self-directed on-boarding process is contemplated in one implementation of the invention, this process and the associated questions are preferably designed to be both robust and understandable. These two objectives are somewhat at odds and may require balancing. If the on-boarding process is too simple, then the publisher characterization may not be able to drive the reverse auction correctly, and the resulting allocations may have poor quality. If the on-boarding process is too complex, then the process itself will become a barrier to both adoption and scalability of the platform. A skilled reader will understand that the process and associated questions should be designed with these factors in mind.

It is noted that gaming of the system by publishers may be limited in a number of ways. First, there is a self-correcting aspect in that if publishers misrepresent their demographic information then they may be less likely to achieve their goals as campaigns will not perform well relative to their inventory. Therefore there is inherently an incentive to provide accurate information for use by the rating system (14). Additionally, the platform may incorporate functionality that builds a profile for publishers over time, based on historical information gathered through the platform based on performance of campaigns, and optionally also external information.

Using a conventional technique or platform, when a campaign is ready to be run, the Operations team may make an initial manual allocation of the entire impression budget of a campaign for example based on predetermined/contracted rates. These predetermined rates may limit the number of impressions that can be given to a publisher in that in order to maintain internal margin goals the operator of the platform will limit allocations to publishers with high rates. This may also mean that the Operations team, in order to maintain margin while fulfilling the impression budget, may buy low quality inexpensive impressions to round out the allocation. Prior art approaches lack a mechanism by which publishers can agree to sell extra inventory by reducing their rate. For the publisher, rate flexibility in exchange for a larger percentage of the buy helps them achieve better utilization of their ad inventory without necessarily racing to the bottom with their price. This permits the testing of reverse auction method concepts.

In one aspect of the invention, the platform may incorporate logic that enables predictive allocations to be made. For example, the platform may include a suggestion engine that may make suggestions both to buyers and also to publishers in regards to their digital advertising related plans or strategies.

Also, allocations may be made to publishers automatically using for example a predictive allocation generated by the analyzer component (described below).

From the point of view of the agency, rate is not the only factor in making a buy. There are generally three main factors of any marketing campaign using electronic ads, namely reach, frequency and duplication. In one aspect of the present invention, the computer system of the present invention is designed to achieve a balance between these factors. A buyer will generally want to achieve maximum reach. Reach refers to the number of consumers who are exposed to an ad. Frequency refers to the number of times the same consumer will views an ad. With most ads, if it is viewed X number of times, then the law of diminishing returns applies if an ad is viewed more than X number of times such that there is no increase in influence. The greater the inventory, the smaller the chance of duplication. The buyer's goal will typically be to maximize reach and achieve an optimal amount of frequency, without undue duplication. The buyer also requires scale in their buying (due to massive time constraints and margin pressure) as well as efficiency in execution and visibility on what they are buying. One without the other leads to a poor buying decision for the agency and a failed campaign.

In one aspect of the invention, the platform balances the interests of the publishers and the advertisers by enabling publishers to be flexible on rate, while providing mechanisms through which frequency, reach, and other factors like campaign and publisher channel attributes, can affect the allocation.

In one aspect of the invention, the RA system (14) may be implemented using a two-phase process. In Phase 1, the platform may automatically allocate publisher inventory to its campaigns, essentially based on prior art methods such as targeting based on demographics. In Phase 2, the reverse auction method of the present invention is used. Phase 1 may result in allocation of most of the impressions being allocated (between 80 and 90 percent of the impressions allocated to a campaign), with the remainder being allocated in Phase 2.

In one aspect of the invention, when a campaign is entered to the RA system (16), the platform (as a function of an analyzer (28) that may be implemented as part of the server application 20) a filtering process is initiated that matches campaigns to publishers based on the suitability of a given campaign to a given publisher. Inputs to this filtering function may include both campaign and publisher characteristics described above, such as campaign channel, campaign targeting, publisher channel etc. Matching of campaigns to publishers may be a one-to-many mapping, i.e., a given campaign can be considered a match to several publishers. The analyzer (28) may incorporate or link to one or more matching utilities. Alternatively, one or more manual operations may be used to match campaigns to publishers.

In one aspect of the invention, the platform results in the inventory of a first publisher competing with the inventory of a second publisher in a way that accounts for qualitative differences between the inventory of the first publisher and the inventory of the second publisher, including as it relates to the various factors relevant to the effectiveness of a particular ad campaign. In one aspect, the platform accounts for the fact that in order for an ad campaign to be effective some qualitative differences will be more relevant than others, illustrated in the examples directly below. Also, these qualitative differences may be hierarchical in nature.

For example a bank may want to mount a national campaign. The inventory of a first publisher (having a variety of different websites and applications) may compete against the inventory of a second publisher (who also has variety of different websites and applications).

For another campaign of the same bank, the bank may want to target only iOS applications, and therefore only iOS applications of the first publisher and the second publishers would compete for impressions related to the ad campaign, by operation of the present platform.

The bank may want to promote the opening of a branch in a particular city. The first publisher may have a publication in that city, and for this campaign, mobile ads localized to the city, regardless of the type of application may compete with other alternatives that address the market of the city in question. Significantly, the rating system of the present invention would rate the publication of the first publisher for the city separately, because the rating system rates properties, and also sub-properties separately, enabling allocation of ads within a sub-hierarchy of the first publisher.

Alternatively, the bank may want to promote the bank opening in the same city but for iOS applications only. The iOS application for the first publisher may be the only relevant publisher content available, however, in this case different sections of the publisher content may compete with one another for the ad impressions, for example the sports section and its rating (from the rating system) would compete with the front page and its rating (from the rating system) whereby the section with the best rating would win the impressions.

The above illustrates that by operation of the rating system every property, application, website and section has a rating, which creates competition between publishers, but also within a publisher's own content, such as their particular media properties, sections and applications.

When a publisher is matched to a campaign, the platform may send a notification using an alerting system. The alerting system may send a notification via a dashboard, or to a mobile application linked to the platform, or by means of an email notification or any other communication medium selected by a user for example by setting preferences in the platform.

Depending on the volume of campaigns entering the RA system, these alerts may be batched into a periodic email. Publishers can then log into the system where they will be given a dashboard view of Phase 1 campaigns that are being offered to them. For each of these campaigns, there may be a set time limit for the publisher to accept the initial impression allocation being offered at the publisher's specifically contracted price. Publishers will be given the option to set default rules to be followed immediately when a Phase 1 campaign is first offered to them, or when the Phase 1 time limit has expired. These rules could be as simple as accepting all Phase 1 offerings, or take into account other variables, e.g., conditional acceptance based on the amount of inventory already allocated during the campaign's run.

After all of the initial offerings in Phase 1 have been resolved (either by direct publisher input or indirectly by the expiration of the Phase 1 timeout), the remaining unallocated impressions will be offered via a modified reverse auction to all publishers in the system (including those that participated in Phase 1). These remaining impressions will be offered as a block at a price ceiling that has been calculated such that the overall effective rate for the entire campaign meets the applicable margin requirements.

Publishers may be allowed to enter a single bid with two components: (1) the number of impressions bid (up to the total impressions being offered in Phase 2), and (2) the rate at which the publisher will provide those impressions. In a prior art reverse auction, after the bidding period has ended, impressions would be allocated to publishers based solely on the price that was bid and the number of impressions that were bid. In a typical prior art auction, a lower bid beats a higher bid. In accordance with one aspect of the reverse auction method of the present invention, allocation of impressions in the reverse auction takes into consideration other factors besides price. These modifications and their impact on both publisher and advertiser can best be illustrated by a concrete example.

What follows is a representative example of a possible use of the platform of the present invention. In this example, a campaign enters Phase 2 with 100,000 impressions that may have been initially priced at $8 CPM. Four publishers (P1, P2, P3, and P4) are participating in Phase 2 for this campaign. Publisher P1 bids for 50,000 impressions at $4 CPM. Publisher P2 bids for 25,000 impressions at $3 CPM. Publisher P3 bids for all 100,000 impressions at $5 CPM. Publisher P4 bids for 75,000 impressions at $6 CPM.

In a prior art reverse auction for an ad campaign comprising multiple identical ad impression units, after the bid phase in this example, the impressions would be allocated as follows: since P2 has the lowest priced bid ($3 CPM) and has requested a number of impressions (25,000) that is less than the current number of unallocated impressions (100,000), P2 is awarded its full bid of 25,000 impressions at $3 CPM. The next lowest bid was made by P1 for 50,000 impressions at $4 CPM. Since there are still enough unallocated impressions to fulfill this bid, Publisher P1 is awarded all 50,000 impressions at $4 CPM, leaving 25,000 impressions remaining to be allocated. Publisher P3 has the next lowest bid at $5 CPM for 100,000 impressions, but is only awarded the 25,000 impressions that remain. Finally, P4 has the last remaining bid, but since there all 100,000 impressions have been awarded to lower bids, P4 gets none of the 75,000 impressions that were requested.

As previously discussed, in accordance with the present invention, price cannot be the sole determining factor when allocating impressions to a campaign. For the publisher, a classic reverse auction such as the one described above results in downward pressure on the price at which they can sell their inventory and assumes that every impression is equal to another regardless of the publisher it originates from. Since publisher inventory supplies can easily satisfy any levels of demand that currently exists in the market, this downward pressure would quickly result in inventory prices racing to whatever floor price has been set in the reverse auction. For the advertiser, awarding impressions based on price alone ignores factors that can have a large impact on the efficacy of a campaign, such as the quality of publisher, number of unique viewers reached, and user demographic.

To address these aspects, in one aspect of the present invention the inventors have invented a number of modifications to the classic reverse auction model. These are incorporated in the RA system (16) and made part of the platform.

One way that the system of the present invention may be configured to address these aspects is by implementing a first modification to dynamically increase a publisher's “effective bid price” as that publisher is awarded impressions. An “effective bid price” means that this price will only be a logical price used to determine the auction winners; the price paid by each winning publisher will still be the actual price bid, as we award more impressions to that publisher. The intended purpose of this modification is to incorporate the notion that as more impressions are awarded to a single publisher, the less effective and thus less valuable those impressions are to a campaign (since they increase the likelihood of duplication, i.e., the likelihood that the ad is being served to someone who has already seen it). This aspect addresses what was discussed earlier in that the platform designed to address the problems of the agency but also the publishers. In this case altering the effective rate addresses the need for the agency to achieve maximum reach with the least duplication amongst their audience.

To illustrate what effect this has on the reverse auction, let us suppose that we will increase the effective bid price by $0.10 for every 1,000 impressions that are allocated to a publisher. In our example above, Publisher P2 has the low bid at $3 CPM for 25,000 impressions. After the first bundle of 1,000 impressions is allocated to P2, the effective bid price is raised to $3.10. Since $3.10 is still the lowest bid, Publisher P2 is allocated another bundle of 1,000 impressions and the effective bid price is raised to $3.20 CPM. This process continues for the first 10,000 impressions until the effective bid price for Publisher P2 is $4 CPM.

At this point, P2 has been allocated 10,000 impressions out of a 25,000 bid. Since the effective bid prices are the same for P1 and P2, we now award impressions in lockstep to both P1 and P2, while also raising their effective bid prices accordingly. Both P1 and P2 will be allocated 10,000 impressions each, raising their effective bid prices from $4 CPM to $5 CPM, at which point they will now be in a tie for lowest bid price with P3. Publisher P2 will now have been awarded a total of 20,000 impressions, and P1 will have been awarded 10,000 impressions.

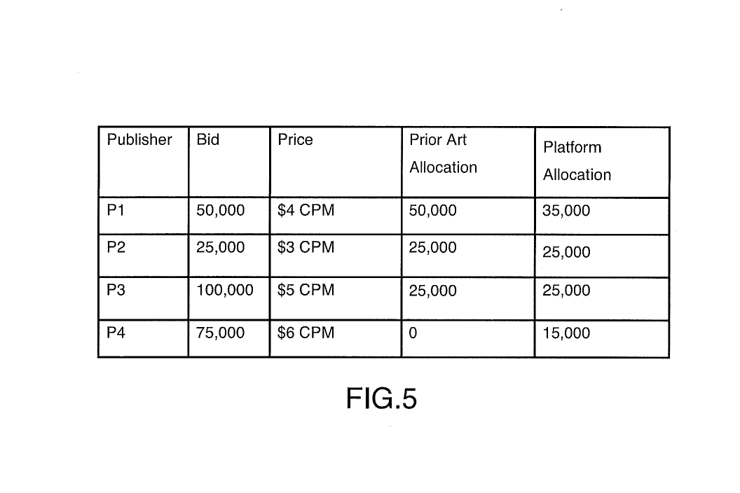

With P1, P2, and P3 all having effective bid prices of $5 CPM, all three publishers will be awarded impressions in lockstep. This will continue for 5,000 impressions each, at which point P2 will have been awarded the full 25,000 impressions of its bid. Publisher P1 will have been awarded 15,000 impressions (of 50,000 impressions bid), and P3 will have received 5,000 impressions (of 100,000 bid). The effective bid price for P1 and P3 is $5.50 CPM, which is still lower than P4′s bid of $6 CPM, meaning that P1 and P3 will continue to be awarded impressions until their effective bid prices match P4. When their effective bid price reaches $6 CPM, Publisher P1 will have been awarded 20,000 impressions, and Publisher P3 awarded 10,000. Including the 25,000 awarded to P2, a total of 55,000 out of the 100,000 impressions that were originally up for auction have now been awarded. Now that P1, P3, and P4 all have the same effective bid price, the remaining 45,000 impressions will be awarded equally amongst them. This final bid information is summarized in the table of FIG. 5.

As this example shows, modifying a prior art reverse auction model to incorporate the elements of the present invention reduces the model's reliance on price as the sole or main metric in determining auction winners. By raising the effective bidding price as more impressions are awarded to a publisher, this modified reverse auction effectively places a higher value on publishers whose inventory has not yet been allocated to a campaign.

It is noted that an assumption is being made that each publisher does not have a duplicated audience. While this assumption is almost certainly incorrect, it is an improvement over the alternative that assumes that every impression is the same. This aspect may be further addressed by using additional mechanisms to avoid duplication, for example by handset matching or fingerprinting (including as described below).

Demographics-only based approaches are often inefficient in reaching the consumers that are most valuable to brands. This is because for a particular advertising campaign an ad impression for consumer A (meeting the demographic criteria) for a content property C that is relevant to the campaign would be more valuable to the advertiser than an ad impression for consumer B (also meeting the demographic criteria) for a content property D that is completely irrelevant to the campaign. Yet prior art approaches would have generally treated both ad impressions as being of equivalent value.

The present invention, in contrast, automatically accounts for the environmental factors related to qualitative attributes of content, that are separate and apart for demographic factors, but relevant to targeting consumers effectively.

In addition, for the first time in digital advertising, the present invention creates an opportunity for the publisher of content property C to charge a premium for the advertising campaign in question. In other words, where content is a better “fit” for an ad campaign, an opportunity is created to charge a better rate.

In another implication of the platform of the present invention, publishers are rewarded for participating in campaigns that are “on brand” and hurt if they try to participate in campaigns that are “off brand”. In exchange for less commoditization of content, and better rates, publishers will be motivated to bid on ad allocations that are a better fit for their inventory. This, in turn, will provide better results for advertisers and may motivate advertisers or brands to see the value of premium content or content that is a better fit for their target demographic and may motivate advertisers or brands to increase the rate they are willing to pay for ad impressions that meet particular qualitative criteria.

This particular modification may provide protection against ad network-style dumping of cheap inventory overwhelming their higher priced premium offerings while giving them access to an efficient market for the execution of mobile media. As discussed previously, the benefit for the advertiser whose campaign is up for auction is that there is a built in bias toward distributing impressions amongst publishers, which should generally result in less duplication and more unique views.

While modifying the reverse auction model in this manner biases the model toward distributing impressions amongst publishers and thus reducing duplicate views, it is true that publishers are not equal with respect to the rate at which duplicate views accumulate as their number of impressions grow (for example, Uber Social™ has 160 m monthly impressions in Canada vs. Winnipeg Free Press which has 500 k). To incorporate this idea into the model, in one aspect of the invention, the platform changes the rate at which the effective bid price grows for each publisher depending on how likely each marginal impression awarded is expected to increase the number of duplicate views. This can be as simple as increasing the effective bid price based on the percentage of a publisher's inventory that is awarded rather than a fixed amount, e.g., increasing the effective bid price by $0.10 for every 0.5% of a publisher's monthly inventory that is awarded. Another possible modification to the prior art reverse auction model is to quantify a publisher's quality and suitability for the campaign being bid.

As discussed previously, another aspect of the present invention is a publisher rating that would incorporate such factors as demographics, channel, and quality of ad spaces. Various rating mechanisms are possible and may be incorporated in to the rating system (14). In another aspect of the invention, one or more rating mechanisms may be used to bias the reverse auction process in favour of publishers whose quality and suitability to the campaign are higher than those of their competitors by, e.g., discounting the initial bid price for a publisher based on its rating.

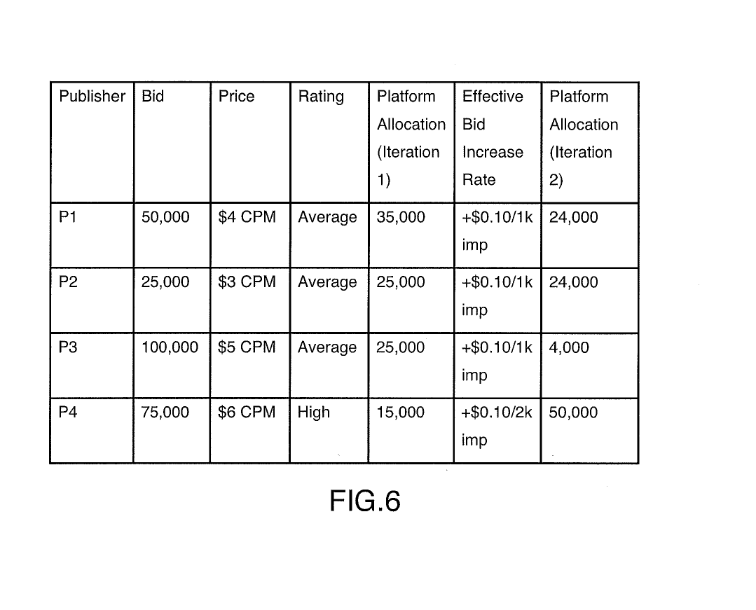

What follows is an example that illustrates how these additional modifications affect the ad bidding model of the present invention. Consider the original example of four publishers, P1, P2, P3, and P4, bidding in a reverse auction of 100,000 impressions. Let us assume that P1, P2, and P3 are roughly similar in terms of publisher quality and in terms of suitability to the campaign, but that publisher P4 has both a larger inventory, and is more suitable in terms of channel and demographic than its competitors. To capture these qualities, P4's effective bid price will increase by $0.10 every 2,000 impressions rather than every 1,000 impressions, and P4's initial effective bid price will be $3 lower than the actual bid price. Given the same bid structure as before, both P2 and P4 tie for the lowest bid at an effective bid price of $3 CPM. Both P2 and P4 are initially awarded impressions, but P4 receives twice as many impressions as P2 for the same incremental increase in effective bid price. When the lowest effective bid price reaches $4 CPM, P2 will have been awarded 10,000 impressions to P4's 20,000 impressions. Following the allocation phase to its conclusion results in the distribution of impressions shown in the column entitled “Effective Bid Increase Rate” in the table of FIG. 6.

In accordance with the example above, publisher P4 has been rewarded for having the best fit to the campaign and for having enough inventory to potentially reduce duplicate views. This results in the awarding of 50% of the impressions available (compared to 0 impressions in the original model) despite P4 having actually bid the highest price.

Many of the publisher and advertiser concerns that were raised in the introduction to this section can potentially be addressed by adjusting the inputs to the publisher ratings, and it is certainly the case that care must be taken to properly configure both the rating system (14) and the specific effects it has on the reverse auction model. For example, while increasing the effective bid price as more impressions are allocated to a publisher addresses in part the presence of duplicated views through the allocation process, the platform as presented implicitly assumes that there is no overlap of audience between different publishers. In one aspect of the invention, the various mechanisms may be used to reduce duplication. For example, fingerprinting may be used to identify particular consumers, and this information may be correlated for example by connecting various websites to the platform using for example a distributed database that allows the tracking of the same consumer across multiple websites.

It is also true that incorporating some notion of allocation quality with respect to the consumer is an important aspect that has not been proposed, prior to the present invention. A skilled reader will understand that various aspects of the platform and method described may be modified in part for example to enhance the manner in which duplication is addressed.

A skilled reader will also understand that the techniques described may be implemented to the platform described in a variety of ways. For example, an algorithm may be provided that incorporates the modifications described, which may be embodied in the RA system (16).

### Rating System

Some aspects of the rating system (14) are already discussed above, especially in connection with the RA system (16) and the information used by the platform to differentiate between publishers and their media properties in connection with the operations of the RA system (16).

In another aspect, the rating system may be implemented as part of the analyzer (28) or analytics engine. The analyzer (28) may include a number of resources that are configurable to embody a series of analytical operations. In one implementation, the analyzer (28) is configured to simulate ad placement rates based on qualitative factors including reach, audience demographics, which may be captured through the on-boarding process, and also may be supplemented using an audience capture tool that is configured to collect information regarding the relevant qualitative attributes of different publishers, and their different media properties.

This information may be collected for example in conjunction with the agreement that may be entered between the operator of the platform and a publisher registering to access the computer system.

The analyzer (28) may dynamically analyze performance of different publishers, such as their CTR, and this information may be used to dynamically assign (and re-assign) a rating for a publisher or a publisher's property.

The analyzer (28) may in some cases obviate the need for publisher on-boarding as previously described, or some aspects of on-boarding may be automated based on the platform obtaining certain information relevant to differentiating between publishers as describe above.

The analyzer (28) may enhance a profile for a publisher over time, which may have been developed initially using information obtained in the on-boarding process. For example, the analyzer (28) may use information obtained by monitoring performance of logged campaigns so as to adjust a publisher's profile, and also adjust their rating.

In another aspect, the analyzer (28) embodies one or more routines or algorithms designed to calculate a “best fit” placement for an advertiser based on their campaign parameters, and available inventory based on probability of particular inventory meeting their campaign parameters. Campaign parameters may include budget, targeting parameters, channel classification and particulars of creative content. A skilled reader will appreciate that various routines algorithms exist or may be used for this purpose. This approach however is very different from the commodity based approach taken by others including GOOGLE™ currently. This is also different from the demographics based approach taken by prior art solutions that does not consider the environment based factors in the manner that does the present invention.

One challenge in designing and operating the platform is around inventory allocation in that it is impossible to know how many publishers will bid on a specific campaign, to what level, and to what rate. In one possible aspect of the present invention, the platform assumes that all publishers that are selected to bid on inventory will bid for the maximum number of impressions available to them creating in turn a scenario where publisher demand exceeds supply. Additionally, in one possible aspect, the platform may be configured based on the assumption that not only will ALL publishers bid on 100% of the available inventory, but that there is the distinct possibility that they will all bid the same price (ex: $0) thereby neutralizing the two most common ways in which inventory is allocated to publishers.

The platform has also been built to take into consideration other variables which will assist in allocating inventory. These variables, identified below, for example acknowledge duplication of audience, reach of audience, ad placement, and consumer rating in app stores for each publisher site.

A skilled reader will understand that the rating system (14) has been built to permit the addition over time of other variables for rating publishers and their ad inventory.

As previously stated, in one possible implementation of the present invention, one aspect that may be embodied in the rating system (14) is the assumption that each subsequent impression (rich or static) allocated to a publication is of less value than the impression before it because of increasing chance of duplication. As a result, the effective rate of each impression (not the actual rate) will increase with each allocated impression creating an allocation with the maximum reach and minimal duplicated audience.

In one possible implantation of the present invention, the rating system (14) may incorporate one or more rating methodologies for rating content based on a series of objective criteria. The rating methodologies may be varied from time to time and may be designed in a way that may help predict ad campaign performance outcomes depending on content attributes, when the content attributes are mapped to campaign attributes. A skilled reader will appreciate that many configurations and rating methodologies may be used.

In one possible implementation, an example rating methodology may be based on (1) the number of monthly impressions, (2) the number of downloads for an application (if the content is an application), (3) the number of unique visitors per mobile site (for mobile web only), (4) click-through rates (CTR), (5) the demographic information, (6) the number of ads per page, (7) application approval rating; (8) sudden changes in app store ratings; (9) download velocity; (10) click-through rate by advertiser vertical; and (11) duplication of audience. These and other factors may be considered. Various different weightings of these factors, and calculations based on these factors and weightings may be used to determine a rating.

In one particular aspect, the rating methodologies may be designed to be objective, and also to be perceived as fair to publishers, which in turn may motivate publishers to create content that is perceived as being more valuable by their target audience, and therefore more valuable to brands whose target audience maps to the publisher's target audience.

In another aspect, the rating system (14) may monitor the performance of publishers in delivering on impressions and depending on this performance their participation in future allocations may be modified by the computer system dynamically. For example if a publisher underperforms on delivering ad impressions with the desired attributes as per their allocation won in an auction; subsequently, their rating may be lowered dynamically and this may reduce the number of ad units sold.

The rating categories in one implementation may include monthly impressions, uniques/downloads, CTR, and number of ads per page. Each category may be associated with its own rating formula that returns a number in a defined range (for example 1.0-5.0), which is then averaged to give an overall rating in the same range. In one aspect, these formulas may all take the form of the ratio of some metric (monthly impressions, ratio of unique views to monthly impressions, click-through rate, number of ads per page) against a “top end” value of that metric, which may give a number between 0.0 and 1.0 for example. That number may then be scaled to a defined range (such as between 0.0 and 4.0) range, and then shifted to be between (1.0 and 5.0). Various possible “top end” values may be used. In fact a skilled reader will understand that various formulas may be used, as well as mechanisms to combine the results of application of the formulas.

What follows illustrates a possible use of one embodiment of the rating system (14):

Regarding the acquisition of information regarding audience, a skilled reader will understand that platform may incorporate one or more tools for acquiring this information.

For example, the analyzer (28) may be used to populate a data engine that is designed to provide visibility into the characteristics of end customers who are viewing the ads being served by the platform. This information can be used to characterize the audience of a publisher, thereby creating a more accurate picture from which to draw a rating for the RA system (14), and ultimately providing a better, more focused buy for the buyer (and thus, a more relevant ad for the end consumer).

The data engine (30) may provide further advantages to participation of publishers and advertisers by binding the publishers and/or advertisers more closely to the platform.

In another aspect of the invention, the platform can be modified to use not only static factors relevant to content quality, but also dynamic factors. These dynamic factors may consist for example of attributes relevant to scoring content that may be established on a dynamic basis, for example by a third party platform or service. An example of such dynamic factors is application ratings, which are commonly used online, including through application stores or app stores.

In one aspect, the rating system (14) may use one or more application ratings, for the purposes of the content rating features of the present invention. The application ratings can be obtained from one or more app stores. These ratings can be used as an additional factor by the rating system (14). One aspect of the invention is the configuration of the rating system (14) to incorporate one or more methodologies for rating content based on dynamic information relevant to quality of content, such as application ratings information.

In one implementation, as shown in FIG. 1, an API (23) may be provided that allows information to be extracted from online platforms that provide access to application ratings or other application scoring data.

In one example, application ratings may be based on a rating of a particular number such as a rating from 1 to 5 scoring system, which is what is used for example in the ANDROID™, iTunes™, and MICROSOFT™ application stores. The BlackBerry application store is currently based on a number from 1 to 10. Many other alternatives are possible.

In one aspect, the platform acquires the application ratings and these are used by the rating system (14) as one aspect of automated scoring of content that is an application.

In another aspect, the rating system (14) may include one or more rules for processing application rating information including for example to ensure its integrity. In one aspect, the rating system (14) equalizes ratings scores across platforms (as one example, the BlackBerry application score is divided by two).

In another aspect, the rating system (14) determines if the content is an application, and if so, then application rating data is obtained used in the rating processes. In one implementation, the application rating data is added to other four (4) variables, providing a fifth variable in addition to ads per page, CTR, impressions and unique visitors/downloads.

In another aspect of the invention, the platform addresses the fact that a score based on a significant number of reviews is more reliable than a score that is based on a small number of reviews. Many application stores for this reason do not publish a rating until critical mass is achieved, which is often one hundred reviews. For example, in one representative implementation, rating information may be shown as a lower score for a period of time until a minimum number of reviews exist, for example this rating may be one out of five until critical mass is achieved. In one aspect of the system, an initial low default application rating may not be applied, in order to avoid application of a lower score that does not actually reflect consumer feedback. The rating system (14) may for example detect first movement of the application score which may be inferred to mean that critical mass has been achieved for the particular application in the particular app store. Therefore, in one aspect the rating system (14) includes a mechanism to require a minimum number of reviews prior to using an application rating for a particular application for content scoring purposes.

In one implementation, the platform (10) is configured to query third party platforms such as application stores, using the API (23), on a scheduled basis. In one representative implementation, the platform automatically retrieves and updates application ratings on a periodic basis, for example on weekly basis, using for example a job scheduler part of the rating system (14), or a job scheduler (25) linked to the rating system (14), once critical mass is determined for a particular application. In some implementations, the operator of the platform obtains information from a publisher that may be required to link to application stores, for example a key or application identifier that may be required in order to set up a ratings update on a third party platform such as an application store.

Other “live” or near live variables are possible. An additional example of a dynamic variable that may be collected by the platform and applied by the rating system (14) may be linking to ad platforms in order to obtain live inventory data for use by the rating system (14).

One implication of the use of application store data is that this allows the integration of consumer feedback into the assessment of content quality.

Other dynamic information may be acquired and used for rating such as for example user feedback regarding other content such as online post, articles, e-books, or other content. Other dynamic information may include user engagement levels. All of this information may be imported to the platform, and optionally processed or filtered to improve relevance for differentiating between publishers and their media properties for the purposes of the RA system (16).

In some applications, gathering detailed information on the viewer of an impression may require that publishers embed special programming into their websites or applications. It is not a requirement that a publisher do this as a large sample of information may be dynamically captured via the ad serving process. When an impression is served to a device, this code will pass information regarding that device to the platform. The platform may then use this information to uniquely identify or fingerprint that device, allowing the publisher to accurately determine the number of unique visitors to a given publisher, as well as to determine the unique audience overlap between publishers. For example, the system of the present invention, may optionally maintain a database of users and their characteristics. Additionally, this fingerprint can also be used as a key under which that user's history and behaviour can be stored. Ultimately, this behaviour information will allow a publisher's audience to be more accurately characterized, improving the efficiency and quality of the RA process. There is also the potential to leverage this information in real-time by having the data engine (30) fingerprint each impression view as it occurs, and using the behaviour information stored for that device to inform the choice of ad being served.

This fingerprinting process may be used to access information for filtering duplicates in allocating ads. Various fingerprinting services may be used.

Another variable considered when determining a correspondence between attributes of an ad campaign and attributes of a publication, is that of “balance”. Balance may be defined as a media allocation that is reflective of the geography, and its corresponding population that the buy is deployed against. For example a National buy in the United States should reflect the proportional distribution of individuals in their various cities and states. If NYC represents 28% of the total USA population a national buy that is balanced should not have more than 28% of its buy originate inside of NYC. The algorithm balances the distributing of citizens by correlating census data and capping the amount of inventory a specific publisher or area can win in an auction.

For example, consider 10 m total National impressions for Canada. A Canadian distribution of citizens may include 10.9% of citizens in Alberta, 13.1% in British Columbia, 3.6% in Manitoba, 2.2% in New Brunswick, 1.5% in Newfoundland, 0.1% in Northwest Territories, 2.8% in Nova Scotia, 0.1% in Nunavut, 38.4% in Ontario, 0.4% in Prince Edward Island, 23.6% in Quebec, 3.1% in Saskatchewan, and 0.1% in Yukon. A Newspaper that is based in Alberta and has 100% of its impressions in the Alberta market would only be able to win at maximum 10.9% of the 10 m impressions that are up for auction assuming of course that they were the only entity in the auction that had any Alberta inventory. A National newspaper would be able to participate in this auction and would be able to win up to 10 m impressions as its audience matches the distribution of the required buy. In another example, consider 10 m impressions in

Alberta only. Here, an Alberta newspaper would be in a position to win all 10 m impressions due to its audience being 100% in Alberta. Additionally, a National Newspaper could also participate but only up to 10.9% of the campaign.

### Finalization Routine

In an implementation, the system of the present invention may calculate a CTR score, App score, and bid score for each publisher to determine a final score for a respective bid. First, the click-through rate score may be calculated for each publisher. The publisher's average CTR may be calculated, and the standard deviation for all CTR may also be calculated. These values are then used to calculate the cumulative distribution function (CDF) for the normal distribution which is the final CTR score for the publisher.

The App score for each publisher may also be calculated by the system of the present invention. The average app rating for all apps in the database may be calculated, and the standard deviation for all app ratings in the database may also be calculated. These values can be used to calculate the cumulative distribution function (CDF) for the normal distribution which is the final app score for the publisher.

The Bid score for each publisher may also be calculated by the system of the present invention. Given that the publisher bid x amount for this auction and the max bid for this auction is y, the Bid score may be calculated as follows:

Bid score=(1−(x/(1.5*y))*100

In an implementation, the CTR score, the App score and the Bid score may be added up for each publisher to produce a final score.

All of the publishers' final scores can then be turned into a percentage of allocation for an auction.

Optionally, this finalization routine or algorithm implemented by the present invention may assign to each publisher a multiplier rating based on monthly impressions, click through rate, app store rating, bid, and demographic information. In order to control how these values contribute to the inventory allocation, the present invention may take the normal distribution of the data to give each of these values a score. The scores may be weighted evenly among all scores and publishers. This process may provide for the determination of how each score affects the final allocations and may further provide for the system to adjust the weights of each score accordingly.

Optionally, the finalization routine or algorithm may also consider time range and geographic targeting. For example, for time range, if an auction has 50000 impressions available for a one week time frame and a publisher has 50000 monthly impressions, then the publisher would not be able to win more than ¼ of their monthly impressions. For example, for geographic targeting, if an auction has 50000 impressions in Calgary and a national publisher has millions of national impressions but only 20000 Calgary impressions then they should not win more than 20000 impressions.

### Optional Details Regarding Dashboards

In another aspect, the publisher dashboard (22) may incorporate various planning, strategy or decision support tools that enable publishers to strategize for bids, and the buyer dashboard (24) may include similar tools but configured for advertisers to plan their campaigns.

Various embodiments of these dashboards and tools are possible. Generally speaking they allow the applicable user to log into a web area that contains their open projects, and also allows them to access historical information for previous campaigns. The publisher dashboard (22) may allow a publisher to log in and see a view of campaigns available to bid on, including based on one or more configurable filters. The filters for example may highlight available campaigns that present a fit between parameters associated with the publishers inventory and objectives associated with the ad campaign. The platform may also generate one or more suggestion messages (using the analyzer (28) and historical performance data) and display these to the publisher such as “this type of campaign you did 3 times in the last year and you won X number of impressions, so you should make Y number of impressions” (or “bid X number of dollars”).

For example, the publisher dashboard 22 may provide for analytics and reporting by publisher or by digital media property. The analytics and reporting may be presented for a particular time period, and analytics and reporting presets may be saved for commonly accessed views. The analytics and reporting may include reporting of biddable impressions and impressions won over the reporting periods, optionally analyzed by month. In this case, the biddable impressions may indicate the total number of impressions offered to the publisher across all auctions that the publisher was invited to during the specified timeframe, and the impressions won may indicate the total number of impressions that the publisher won through all auctions during the specified timeframe. This information may be presented in bar graphs, or by any other type of data visualization. Other analytics and reporting information presented may include biddable revenue (total revenue offered to the publisher across all auctions that the publisher was invited to during the specified timeframe), revenue won (total revenue that the publisher won through all auctions during the specified timeframe), revenue per week (total weekly revenue for all of the publisher's auctions in the specified time frame), and an indication of invites accepted (total number of auction invitations that the publisher accepted during the specified timeframe) vs. declines (total number of auction invitations that the publisher declined during the specified timeframe) vs. no response (total number of auction invitations that the publisher did not respond to during the specified timeframe).

The publisher dashboard 22 may also provide for a bid history screen for each advertising campaign. The bid history screen may include: campaign (flight) name; close date; status; bid rate; impressions; impressions won; % of impressions won; cost model; and revenue.

The buyer dashboard 24 may provide for a screen for buyers/advertisers to view all publishers bidding for a particular advertising campaign, and information regarding the respective bids. The information for each bid presented may include: publisher name; bid status (e.g. bid placed, invited, declined); notifications regarding particular bid; bid price/rate (which may be the effective bid rate as described herein); and impressions won for each bid.

Various possible tools may be incorporated into these dashboards.

### Example in Operation

While the description thus far includes a number of examples that illustrate the implications of the use of the platform of the present invention, it is useful to consider an end-to-end example that illustrates the operation of the present invention.

Consider an advertising campaign for a bank, BMO (Bank of Montreal). The campaign consists of a 2 million impression buy using standard banners over 6 weeks. The agency representing BMO, for efficiency and margin reasons, prefers to do their buying through a real-time buying (RTB) platform. RTB platforms are efficient because they provide access to an enormous amount of inventory across a variety of publishers through a single dashboard. The buying agent simply needs to log in to a dashboard to set a bid price and target impression level to fulfill this campaign. Since the inventory supply in RTB systems are typically much higher than the accompanying demand for that inventory, a very low bid price, e.g., $1 CPM is sufficient to fulfill a campaign such as the one we have described. The downside to this, however, is that beyond a few crude controls (such as blocking out a few objectionable categories like adult entertainment), there is no way for the buying agency to purchase impressions from specific properties. Moreover, an ad network with an abundance of non-premium inventory has a tremendous incentive to sell that inventory through an RTB system at a low rate (since this will allow them to achieve a high fill rate). Meanwhile, premium publishing brands that would be a much better fit for this advertising campaign have no way to ensure that they get a large portion of this buy; even if they reduce the rate to compete with non-premium inventory, there is no guarantee through the RTB system that they will be purchased, since they will experience extreme competition even at the lowest rates. This confluence of factors results in the BMO campaign being fulfilled by ad networks such as AMOBEE™. While the cost to fulfill the campaign is low (at $1 CPM, the campaign costs the agency $2000), the BMO ads end up on wildly incompatible properties in the Amobee network, e.g., mobile apps like 25000 Free Jokes and My Zoo Animals.

Despite the low cost of the RTB campaign, BMO is willing to spend much more than $2000 to ensure that a majority of their buy ends up on a premium property that is more appropriate to their campaign. In fact, they are willing to spend as much as $15 CPM for premium inventory that fits their campaign. Meanwhile, the New York Times, a premium publisher brand with an audience consisting of a large number of professionals who have an interest in finance, i.e., a core target of the BMO campaign, feels that their ad impressions are worth much more than $1 CPM, and so refuse to put their inventory in an RTB system to compete with ad networks like Amobee. Despite the apparent fit between advertiser and publisher, there is no way for them to be matched up in an RTB system without, at minimum, the New York Times dropping their rate to compete with the ad networks. However, the existence of the reverse auction system of the platform, modified in accordance with the present invention, takes publisher quality into account and allows this match to occur.

Using the present platform, BMO enters its campaign into the platform rather than buying through an RTB platform. Apart from supplying standard parameters such as dates, number of impressions, and a maximum CPM rate, BMO enters information that helps define the campaign, such as it being targeted at the Financial channel. Since the New York Times audience is a match for these parameters, the platform sends a notification to the New York Times or their agent that the BMO campaign is available (or this is provided through the publisher dashboard (22). The publisher or their agent log into the platform (again this may be through the publisher dashboard (22)). The agent logs into the platform; is presented with the BMO campaign, and bids what may be a preferred rate for the New York Times for example $9.50 CPM. Meanwhile, an agent for Z103.5, another premium publisher whose audience consists mostly of teens and twenty-something's, is logged into platform and sees the BMO campaign in a list of available campaigns. Z103.5 is a fair fit for the campaign since BMO would also like to reach a young audience just entering their professional lives and who are still in the process of forming their brand loyalty with respect to their banking needs. Z103.5 also has available impressions for the next six weeks that they would like to fill, and so their agent also places a bid for half the impressions at their preferred rate of $8 CPM.

Finally, an agent for AccuWeather™ also logs in, sees the campaign, and bids for all the impressions at $1 CPM hoping that the low bid will garner a majority of the impressions.

If price was the only factor considered in the auction, then AccuWeather, being the low bidder, would win all of the impressions, resulting in a campaign indistinguishable to the RTB campaign, where BMO's campaign would frequently appear on irrelevant content. However, due to the rating system (14) and the reverse auction system (16) the New York Times and Z103.5 garner the vast majority of impressions, with the New York Times winning the most impressions due to having the strongest rating in the auction (since they have premium publishing characteristics and their audience is exactly on target for the BMO campaign). This is in spite of the fact that the New York Times made the highest bid at $9.50. Both the New York Times and Z103.5 are satisfied that they were able to participate on a buy that they would have been excluded from in the RTB (or exchange) system, and were able to do so at a rate that they feel their inventory is worth. BMO is also satisfied that their campaign has been fulfilled on publishing properties that are more likely to reach the audience that they are targeting. Without Nectar, BMO would not have been able to buy these premium impressions even though they were willing to spend more to acquire those properties.

### Advantages

The platform provides a mechanism for advertisers to place ads, and allocate advertising budgets, based on qualitative parameters, and not solely quantitative matters, or pricing that does not reflect qualitative parameters. The platform unlocks the premium value of particular ad inventory, when used by particular consumers to access particular ads; and reduces the commoditization of digital ads that results from use of prior art platforms and ad networks. The platform provides better opportunities for advertisers and brands to reach their target audience, and to mount effective campaigns.

The platform integrates publishers and advertisers/brands in an environment where they are able to make more intelligent decisions around digital advertising strategies. These intelligent decisions ultimately provide better results for both publishers and advertisers/brands.

The platform enables targeting based on demographics, but also based on more environmental factors that are also important to effective campaigns, and yet have been ignored by prior art solutions.

This results in better return on investment to advertisers, especially in relation to “premium” content. In turn, this provides an economic base for premium content, which provides the continued benefit to advertisers of access to this premium content that better meets their targeting objectives in relation to consumers.

Content that has premium value for example based on the consumers that the media assets attract and/or their influence on consumer, can command a better price in an ad network for the first time based on the present invention.

Additionally, the present invention integrates a series of tools to that allow brands and agencies to make decisions on ad inventory beyond rate, for both online ads as well as mobile ads. The platform allows publishers and advertisers to participate in an agnostic, efficient marketplace to trade media.

The platform provides an efficient process to allocate publisher inventory, and introduces market forces into the allocation process, alleviating the need for the operator of the platform to set prices for publisher inventory, which reduces overhead and also gives publishers visibility into the market forces that they have been relatively sheltered from in prior art solutions.

The platform allows publishers to further differentiate their products, including using the tools provided.

The platform provides a robust and scalable Reverse Auction exchange that aggregates publisher inventory and advertiser buys into a single powerful marketplace.

### Further Aspects of Implementation

A skilled reader will understand that the platform may include various other resources, or may connect to various other third party resources.

For example the platform may include or link to one or more transaction servers to manage incoming information from publishers, and coordinate its transmission to both the fingerprinting and data management services. It is important that the platform be architected or associated cloud service designed in a way that latency, scalability and robustness are addressed, particularly as the present invention adds several steps in between ad requests and ad servers, which cannot have a negative impact on real time or near real time operations.

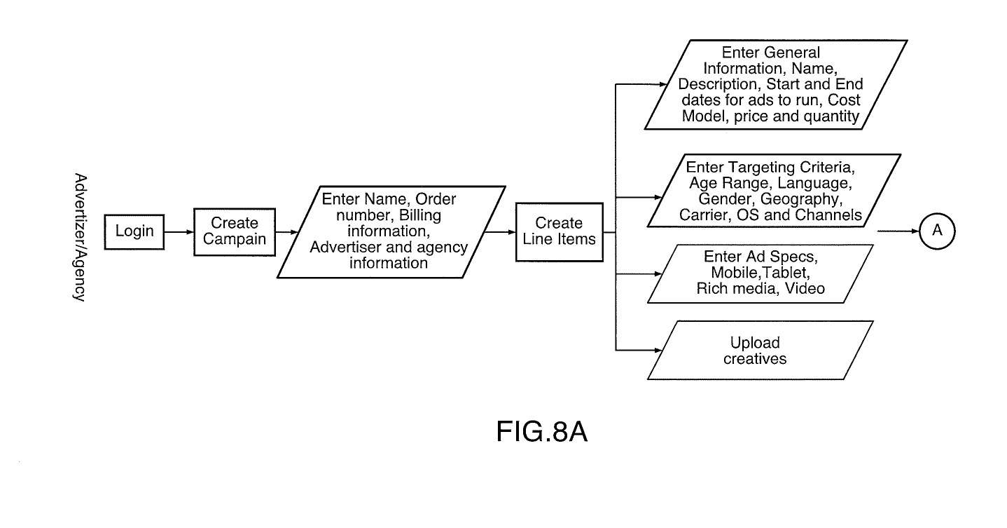

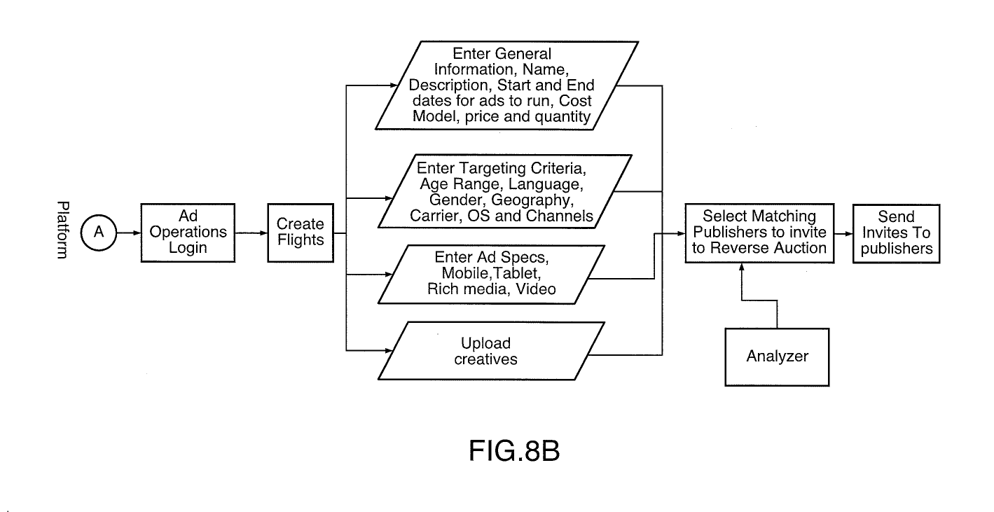

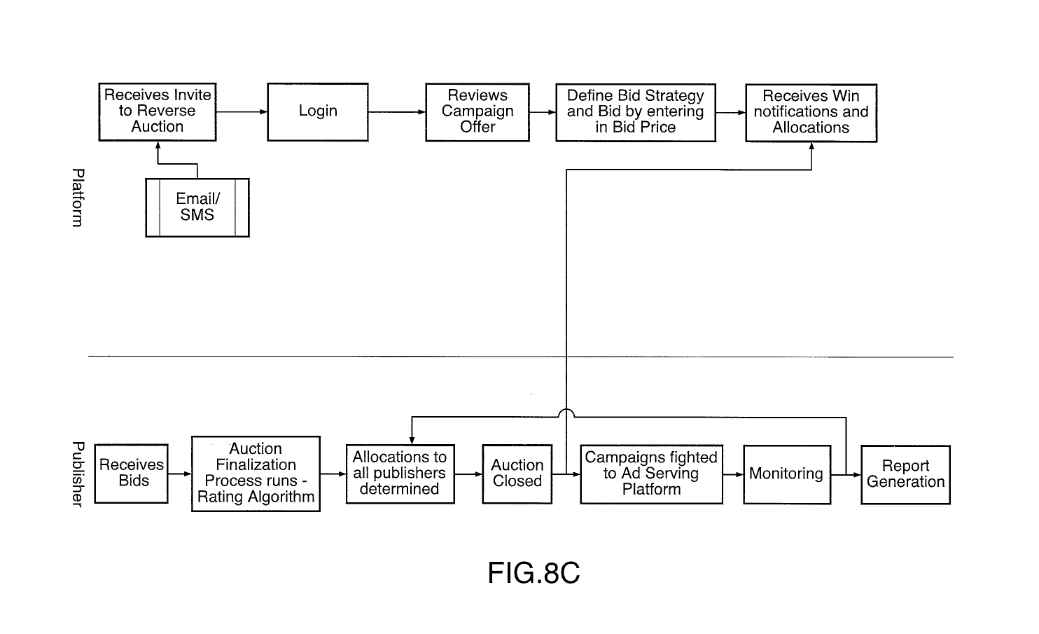

The reverse auction process of the present invention is shown in FIGS. 8A-8C. First, the advertiser/buyer logs in to the system of the present invention, then creates an advertising campaign. The advertiser enters information including: campaign name, order number, billing information, advertiser and agency information. The advertiser creates line items including: (1) entering general information, name, description, start and end dates for ads to run, cost model, price and quantity; (2) entering targeting criteria, age range, language, gender, geography, carrier, OS, and channels; (3) entering ad specs, mobile, tablet, rich media, video; and (4) upload creatives. The advertiser operations logs in and creates flights similarly to the ad campaign creation. Then the advertiser/ad operations selects matching publishers to invite to the reverse auction for the campaign. Invites are sent to publishers. The publisher receives the invitation to the reverse auction optionally by email or SMS, logs in to the system, reviews the campaign offer, and defines a bid strategy and bid by entering in bid price for a digital media property associated with the publisher. The system receives the bids, and runs the auction finalization process, including the rating algorithm of the present invention. The system allocates ad impressions to publishers and closes the auction. The publisher receives win notifications and allocations. The system then flights campaigns to the ad serving platform, monitors and ads served, and generates reporting and analytics information.

### (i) System Implementations

The present invention may be implemented using a distributed and networked computing environment comprising at least one computing device. In a particular implementation, at least three sets of computing devices may be provided. Each set of computing devices may comprise one or more computing devices linked by a network. Typically, at least one set of computing devices would generate campaign attributes and send these over the network to a second set of computing devices. The second set of computing devices receives the campaign attributes and launches a campaign for advocates using these campaign attributes. A third set of computing devices may be used by publishers, and a fourth set of computing devise may be used by advertisers.

Various users include platform client users (administrators) and advocate users may be associated with any manner of network-connected computer device. The network-connected device may be a computer device such as a desktop computer, laptop computer, tablet computer or other similar device, connectable to the platform via the Internet for example by means of a browser session, in order to access one or more web forms that may correspond to the record described below, or an aspect of the record.

### (ii) Mobile Implementations

The network-connected device may also be a mobile device such as a smart phone, and completion of various activities by for example using a mobile application loaded to the mobile device or smart phone. Further implementation details are provided below.

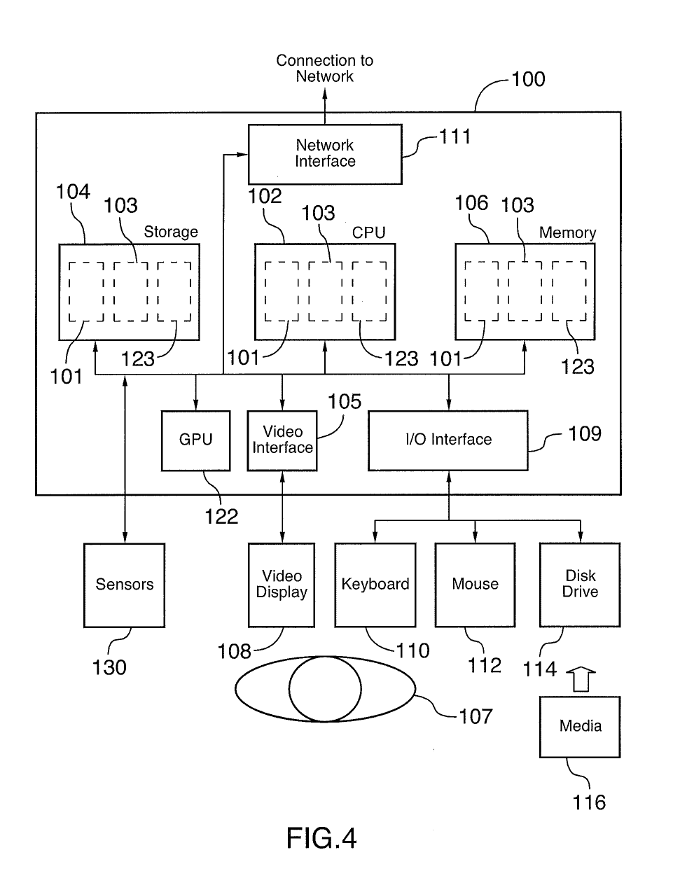

Further enhancements may be provided wherein one or more of the computing devices are mobile devices or wirelessly networked devices, for example as illustrated in FIG. 4. For example, the network may be or include a wireless network, the wireless network including a wireless gateway for linking the wireless network to the Internet. The network-connected devices as previously described may consist of wirelessly networked devices (50) that are operable to access the Internet via a wireless gateway (52). The wirelessly networked devices described may include a browser for interacting with the web server (10) to access functions of the web application (12). Alternatively, the wirelessly networked device (50) may include a mobile application (54), which may include one or more utilities or features providing the record completion function (36) which interoperates with the web server (10) to enable completion of records using the wirelessly networked device (50). The wirelessly networked devices could also be equipped with additional functionality for providing information regarding users that enables the targeting of particular users, including for example a GPS receiver operable to provide GPS location information to invite particular users to complete tasks or sub-tasks or to allocate tasks to particular participating users. The wirelessly networked devices may also include one or more accelerometers or other movement sensors operable to provide movement-based or gesture-based information. Thus the messaging to be returned to the platform may include location, movement and/or gesture relevant content.

It should be understood that the wirelessly networked device as described may consist of a hand-held two-way wireless paging computer, a wirelessly enabled palm-top computer, a mobile telephone with data messaging capabilities, a portable digital media player, or a wirelessly enabled laptop computer, but could be any type of mobile data communication device capable of sending and receiving messages via a network connection. The majority of current mobile communication device users, however, use a mobile telephone with data messaging capabilities, such as server addressing capabilities such as Short Message Service (“SMS”) or Multimedia Messaging Service (“MMS”) or data including GPRS or 3G. The present invention therefore provides means for providing the functionality described herein, from mobile communication devices that are relatively common and inexpensive.

(iii) Generic Implementation

The present invention may be practiced in various embodiments. A suitably configured computer device, and associated communications networks, devices, software and firmware may provide a platform for enabling one or more embodiments as described above. By way of example, FIG. 4 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In a known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present invention may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (a.g. an optical disc, a magnetic disk, a tape, etc.), on one or more data storage portioned of a computing device, such as memory associated with a computer and/or a storage system.

While the above description provides examples of one or more embodiments of the invention, it will be appreciated that numerous other embodiments may be within the scope of the present invention, as defined by the following claims.

1. A computer network implemented system comprising:
(a) at least one computer processor and at least one non-transitory computer readable medium storing computer processing instructions;
(b) a registration component;
(c) an advertising campaign component; and
(d) a reverse auction component;
(e) wherein, upon execution of the computer processing instructions by the at least one computer processor:
(i) the registration component associates at least one publisher with at least one digital media property, and associates at least one attribute with the at least one digital media property, the at least one attribute including at least one content quality attribute;
(ii) the advertising campaign component associates at least one advertising campaign with at least one advertising impression attribute, the at least one advertising campaign comprising a plurality of advertising impressions to be allocated;
(iii) the reverse auction component provides for the processing of at least one bid by the at least one publisher to allocate at least a portion of the plurality of advertising impressions of a respective one of the at least one advertising campaign to the at least one digital media property associated with the at least one publisher; and
(iv) the reverse auction component allocates the at least a portion of the plurality of advertising impressions to the respective at least one digital media property that is a subject of the at least one bid based at least partly on a determined correspondence between the at least one attribute associated with the respective at least one digital media property and the respective at least one advertising impression attribute.

2. The system of claim 1, wherein the determined correspondence comprises a determined correspondence between the at least one content quality attribute associated with the respective at least one digital media property and the respective at least one advertising impression attribute.

3. The system of claim 1 comprising an advertising campaign planning component wherein, upon execution of the computer processing instructions by the at least one computer processor, the advertising campaign planning content provides for the defining of the at least one advertising impression attribute by at least one buyer.

4. The system of claim 1 wherein the at least one bid is created based at least partly on the plurality of advertising impressions to be allocated.

5. The system of claim 1, wherein the at least one content quality attribute associated with the at least one digital media property comprises static information.

6. The system of claim 1, wherein the at least one content quality attribute associated with the at least one digital media property comprises dynamic information.

7. The system of claim 6, wherein the dynamic information comprises an aggregation of user submitted ratings of the at least one digital media property.

8. The system of claim 6, wherein the dynamic information comprises an aggregation of user submitted ratings of the at least one publisher associated with the digital media property.

9. The system of claim 1, wherein the at least one content quality attribute associated with the at least one digital media property is received from a third party platform.

10. The system of claim 1, wherein the at least one content quality attribute associated with the at least one digital media property comprises information related to the publisher associated with the respective digital media property.

11. The system of claim 1, wherein the at least one content quality attribute associated with the at least one digital media property comprises information related to the respective digital media property.

12. The system of claim 1, wherein the determined correspondence comprises mapping each of the at least one attribute associated with the respective at least one digital media property to a predefined common scoring range, averaged amongst all of the at least one attribute and determining a correspondence between the attribute average and the at least one advertising impression attribute.

13. The system of claim 12 wherein the attribute average comprises a weighted average, wherein each of the at least one attributes comprises an associated attribute weight, and the average is determined in accordance with the respective associated attribute weight.

14. The system of claim 1 wherein the at least one attribute associated with the respective at least one digital media property comprises at least one of: a number of monthly impressions; a number of downloads of the digital media property; a number of unique visitors; click-through rate; demographic information of visitors; a number of ads per page of the digital media property; and digital media property approval rating.

15. The system of claim 1 wherein the at least one digital media property is exposed by the reverse auction component for buying of advertising.

16. The system of claim 1 wherein the at least one digital media property is exposed to at least one non-guaranteed real-time bidding exchange for buying of advertising.

17. The system of claim 1 wherein the at least one bid comprises a number of advertising impressions and a rate at which the advertising impressions will be provided, wherein the reverse auction component allocates the at least a portion of the plurality of advertising impressions to the respective at least one digital media property that is a subject of the at least one bid based at least partly on the number of advertising impressions and the rate at which the advertising impressions will be provided.

18. The system of claim 1 wherein the reverse auction component calculates an effective bid price for each of the at least one bid, each effective bid price based at least partly on a number of advertising impressions awarded to the respective bid by the reverse auction component, the reverse auction component allocating the at least a portion of the plurality of advertising impressions to the respective at least one digital media property that is a subject of the at least one bid based at least partly on the effective bid price of the respective at least one bid.

19. The system of claim 18 wherein the effective bid price of a respective bid is re-calculated by the reverse auction component upon awarding a predefined number of advertising impressions to the respective bid.

20. The system of claim 18 wherein the effective bid price of the at least one bid is based at least partly on a geographic distribution reach of the at least one digital media property associated with the at least one bid.

21. The system of claim 1 wherein the reverse auction component provides at least one bid recommendation based at least partly on the at least one attribute associated with the at least one digital media property content attributes and the at least one advertising impression attribute.

22. The system of claim 1 wherein the reverse auction component determines a final bid score for the at least one bid based at least partly on a click-through rate score, app score, and bid score, and wherein the determined correspondence is based at least partly on the final bid score.

23. The system of claim 22 wherein the click-through rate score is based at least partly on an average click-through rate associated with the respective at least one publisher and a standard deviation for click-through rate.

24. The system of claim 22 wherein the app score is based at least partly on an average app score associated with the respective at least one publisher and a standard deviation for app score.

25. The system of claim 22 wherein the bid score is based at least partly on a bid amount associated with the respective at least one publisher and a maximum bid for the respective at least one advertising campaign.

26. A computer network implemented method performed by at least one computing, the method comprising:
(a) associating at least one publisher with at least one digital media property, and associating at least one attribute with the at least one digital media property, the at least one attribute including at least one content quality attribute;
(b) associating at least one advertising campaign with at least one advertising impression attribute, the at least one advertising campaign comprising a plurality of advertising impressions to be allocated;
(c) providing for the processing of at least one bid by the at least one publisher to allocate at least a portion of the plurality of advertising impressions of a respective one of the at least one advertising campaign to the at least one digital media property associated with the at least one publisher; and
(d) allocating the at least a portion of the plurality of advertising impressions to the respective at least one digital media property that is a subject of the at least one bid based at least partly on a determined correspondence between the at least one attribute associated with the respective at least one digital media property and the respective at least one advertising impression attribute.

27. The method of claim 26, comprising providing at least one bid recommendation based at least partly on the at least one attribute associated with the at least one digital media property content attributes and the at least one advertising impression attribute.
